(19) United States
(12) Patent Application Publication
(10) Pub. No.: US 2025/0178185 A1
(43) Pub. Date: Jun. 5, 2025

(54) WEARABLE DEVICE AND OPERATING METHOD THEREFOR

(71) Applicant: Samsung Electronics Co., Ltd., Suwon-si (KR)

(72) Inventor: Yonghyun PARK, Suwon-si (KR)

(21) Appl. No.: 19/049,632

(22) Filed: Feb. 10, 2025

Related U.S. Application Data
(63) Continuation of application No. PCT/KR2023/014596, filed on Sep. 25, 2023.

(30) Foreign Application Priority Data
Nov. 2, 2022 (KR) 10-2022-0144712

(51) Int. Cl. B25J 9/00; A61H 3/00; B25J 13/08

(52) U.S. Cl. CPC B25J 9/0006; A61H 3/00; B25J 13/085; B25J 13/088

(57) ABSTRACT

A wearable device configured to be worn on a user's body may include: a driving module for generating an external force applied to the user; a torque sensor module for measuring torque caused by at least one of the operation of the driving module and the movement of the user to generate torque data; a wireless power transmitter for performing wireless power transmission; a wireless power receiver for receiving wireless power transmitted by the wireless power transmitter, converting the received wireless power, supplying the converted wireless power to the torque sensor module, and receiving the torque data from the torque sensor module to transmit the torque data to the wireless power transmitter; and a processor for controlling the driving module so that the driving module generates the external force, receiving the torque data from the wireless power transmitter through the driving module, and evaluating the movement using the torque data.

### CROSS-REFERENCE TO RELATED APPLICATIONS

This application is a continuation application of International Application No. PCT/KR2023/014596 designating the United States, filed on Sep. 25, 2023, in the Korean Intellectual Property Receiving Office and claiming priority to Korean Patent Application No. 10-2022-0144712, filed on Nov. 2, 2022, the disclosures of which are all hereby incorporated by reference herein in their entireties.

### BACKGROUND

### Field

Certain example embodiments relate to a wearable device (or a robot (e.g., a manipulator, etc.)) and/or an operating method thereof.

### Description of Related Art

A wearable device may apply an external force to a user to assist the user with an exercise. For example, the wearable device may provide the user with an assistance force that assists the user in movement or a resistance force that acts as a resistance to the movement of the user.

### SUMMARY

According to an example embodiment, a wearable device worn on a body of a user may include: a driving module, comprising a motor and/or circuitry, configured to generate an external force to be applied to the user; a torque sensor module, comprising a sensor, configured to generate torque data by measuring a torque caused by at least one of an operation of the driving module or a movement of the user; a wireless power transmitter configured to perform wireless power transmission; a wireless power receiver configured to receive wireless power transmitted by the wireless power transmitter, convert the received wireless power, supply the converted wireless power to the torque sensor module, and receive the torque data from the torque sensor module and transmit the received torque data to the wireless power transmitter; and a processor, comprising processing circuitry, configured to control the driving module such that the driving module generates the external force, receive the torque data from the wireless power transmitter via the driving module, and evaluate the movement using the torque data.

According to an example embodiment, a wearable device worn on a body of a user may include: a driving module configured to generate an external force to be applied to the user; a torque sensor module configured to generate torque data by measuring a torque caused by at least one of an operation of the driving module or a movement of the user; a wireless power transmitter configured to perform wireless power transmission; a wireless power receiver configured to receive wireless power transmitted by the wireless power transmitter, convert the received wireless power, and supply the converted wireless power to the torque sensor module; a first wireless communication unit configured to receive the torque data from the torque sensor module; a second wireless communication unit configured to receive the torque data from the first wireless communication unit; and a processor configured to control the driving module such that the driving module generates the external force, receive the torque data from the second wireless communication unit, and evaluate the movement using the torque data.

According to an example embodiment, an operating method of a wearable device may include: providing, by a driving module in the wearable device, an external force to a user; transmitting, by a wireless power transmitter in the wearable device, wireless power to a wireless power receiver in the wearable device; converting, by the wireless power receiver, the wireless power; supplying, by the wireless power receiver, the converted wireless power to a torque sensor module in the wearable device; generating, by the torque sensor module in the wearable device, torque data by measuring a torque caused by at least one of an operation of the driving module of the wearable device and a movement of the user; transmitting, by the wireless power receiver, the torque data to the wireless power transmitter; transferring, by the wireless power transmitter, the torque data to a processor in the wearable device; and evaluating, by the processor, the movement using the torque data.

### BRIEF DESCRIPTION OF DRAWINGS

FIG. 1 is a diagram illustrating an overview of a wearable device worn on a body of a user according to an example embodiment.

FIG. 2 is a diagram illustrating an example of an exercise management system including a wearable device and an electronic device according to an example embodiment.

FIG. 3 is a rear view of an example of a wearable device according to an example embodiment.

FIG. 4 is a left side view of an example of a wearable device according to an example embodiment.

FIGS. 5A and 5B are diagrams illustrating example configurations of a control system of a wearable device according to an example embodiment.

FIG. 6 is a diagram illustrating an example of an interaction between a wearable device and an electronic device according to an example embodiment.

FIG. 7 is a diagram illustrating an example configuration of an electronic device according to an example embodiment.

FIGS. 8, 9, and 10A through 10B are diagrams illustrating examples of a driving module, a torque sensor, and an output link of a wearable device according to an example embodiment.

FIGS. 11A, 11B. 12, and 13A through 13B are block diagrams illustrating example configurations of a wearable device according to an example embodiment.

FIGS. 14, 15, and 16A through 16B are block diagrams illustrating other example configurations of a wearable device according to an example embodiment.

### DETAILED DESCRIPTION

The following detailed structural or functional description is provided merely as an example, and various alterations and modifications may be made to the example. Accordingly, actual implementations are not construed as limited to certain example embodiments of the disclosure and should be understood to include all changes, equivalents, and replacements within the idea and the technical scope of the disclosure.

Although terms such as “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the disclosure.

It is to be understood that when a component is referred to as being “connected to” another component, the component may be directly connected or coupled to the other component or intervening component(s) may be present therebetween. Thus, “connected” herein covers direct and indirect connections.

As used herein, the singular forms are intended to include the plural forms as well, unless the context clearly indicates otherwise. It should be further understood that the terms “comprises,” “comprising,” “includes,” and/or “including,” when used in this disclosure, specify the presence of stated features, integers, steps, operations, elements, components, or a combination thereof, but do not preclude the presence or addition of one or more other features, integers, steps, operations, elements, components, and/or groups thereof.

Unless otherwise defined, all terms, including technical and scientific terms, used herein have the same meaning as commonly understood by those having ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments are described in detail with reference to the accompanying drawings. When describing the embodiments with reference to the accompanying drawings, like reference numerals refer to like elements and a repeated description related thereto is omitted.

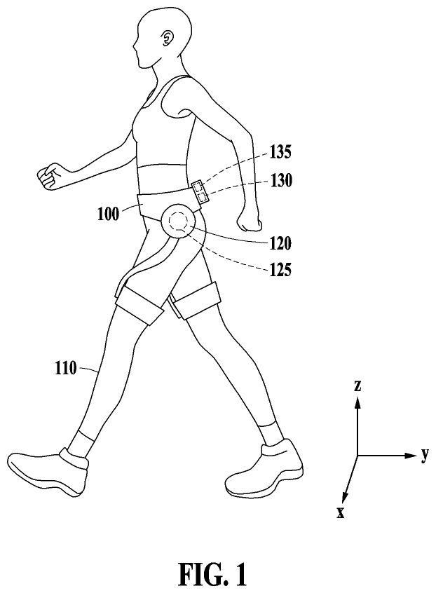

FIG. 1 is a diagram illustrating an overview of a wearable device worn on a body of a user according to an embodiment.

Referring to FIG. 1, a wearable device 100 may be a device that is worn on a body of a user 110 to assist the user 110 in walking, doing an exercise, and/or working more readily. In an example embodiment, the wearable device 100 may be used to measure a physical ability (e.g., a walking ability, an exercise ability, and/or an exercise posture) of the user 110. The term “wearable device” used herein may be replaced with a “wearable robot,” “walking assistance device,” or “an exercise assistance device.” The user 110 may be a human or an animal, but examples of which are not limited thereto. The wearable device 100 may be worn on the body (e.g., a lower body (e.g., legs, ankles, knees, etc.), an upper body (a torso, arms, wrists, etc.), or a waist) of the user 110 to apply an assistance force and/or a resistance force to a physical movement of the user 110. The assistance force, which is a force applied in the same direction as that of a physical movement of the user 110, may assist the user 110 in performing the physical movement. The resistance force, which is a force applied in a direction opposite to that of a physical movement of the user 110, may hinder the user 110 from performing the physical movement and may also be referred to as an “exercise load.”

In an example embodiment, the wearable device 100 may operate in a walking assistance mode to assist the user 110 in walking. In the walking assistance mode, the wearable device 100 may assist the user 110 in walking by applying, to the body of the user 110, an assistance force generated from a driving module 120 of the wearable device 100. As the wearable device 100 assists the user 110 with a force required for the user 110 to walk, it may enable the user 110 to walk independently or walk for a longer period of time and may thereby increase a walking ability of the user 110. The wearable device 100 may also improve a gait of a walker with an abnormal walking habit or walking posture.

In an example embodiment, the wearable device 100 may operate in an exercise assistance mode to enhance an exercise effect of the user 110. In the exercise assistance mode, the wearable device 100 may hinder the user 110 from performing a physical movement or apply resistance to a physical movement of the user 110 by applying, to the body of the user 110, a resistance force generated from the driving module 120. For example, when the wearable device 100 is a hip-type wearable device that is to be worn on the waist (or pelvis) and legs (e.g., thighs) of the user 110, the wearable device 100 may provide an exercise load to a leg movement of the user 110 while being worn on the legs of the user 110 and may thereby enhance further an exercise effect on the legs of the user 110. In an example embodiment, the wearable device 100 may apply the assistance force to the body of the user 110 to assist the user 110 in doing an exercise. For example, when a physically challenged or elderly person attempts to do an exercise with the wearable device 100 worn on their body, the wearable device 100 may provide an assistance force for assisting a physical movement during their exercise. In an example embodiment, the wearable device 100 may provide the assistance force and the resistance force in a combined way according to each exercise interval or time interval, for example, by providing the assistance force in an exercise interval and the resistance force in another exercise interval.

In an example embodiment, the wearable device 100 may operate in a physical ability measurement mode to measure a physical ability of the user 110. While the user 110 is walking or doing an exercise, the wearable device 100 may measure movement information of the user using sensors (e.g., an angle sensor 125 and an inertial measurement unit (IMU) 135) provided in the wearable device 100 and evaluate a physical ability of the user based on the measured movement information. For example, based on the movement information of the user 110 measured by the wearable device 100, a gait index or an exercise ability index (e.g., muscular strength, endurance, balance, and exercise posture) of the user 110 may be estimated. The physical ability measurement mode may include an exercise posture measurement mode for measuring an exercise posture performed by a user.

Although FIG. 1 illustrates the hip-type wearable device as an example for ease of description, a type of the wearable device 100 is not limited to the illustrated hip type. For example, the wearable device 100 may be provided in a type that is worn on other body parts (e.g., upper limbs, lower limbs, hands, calves, and feet) in addition to the waist and legs (thighs, in particular), and the shape and configuration of the wearable device 100 may vary according to a body part on which it is worn.

Further, embodiments of the wearable device 100 described herein may be applied to robots (e.g., manipulators, etc.).

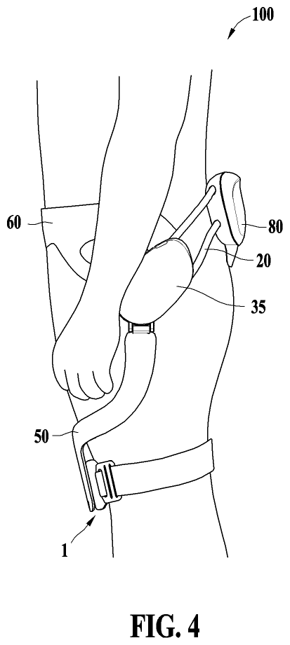

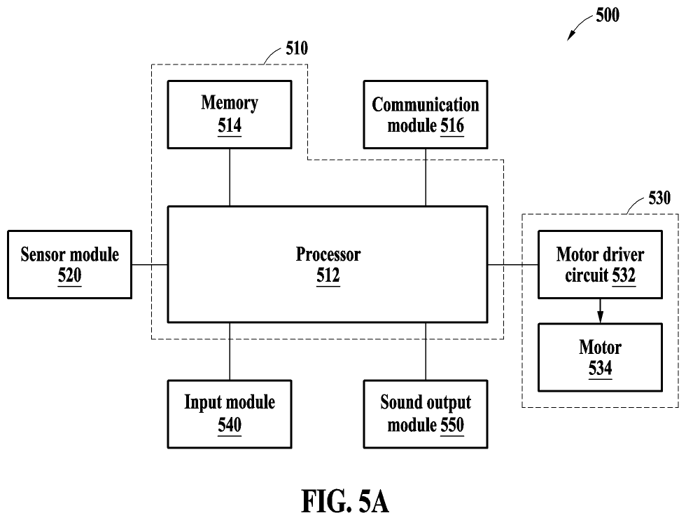

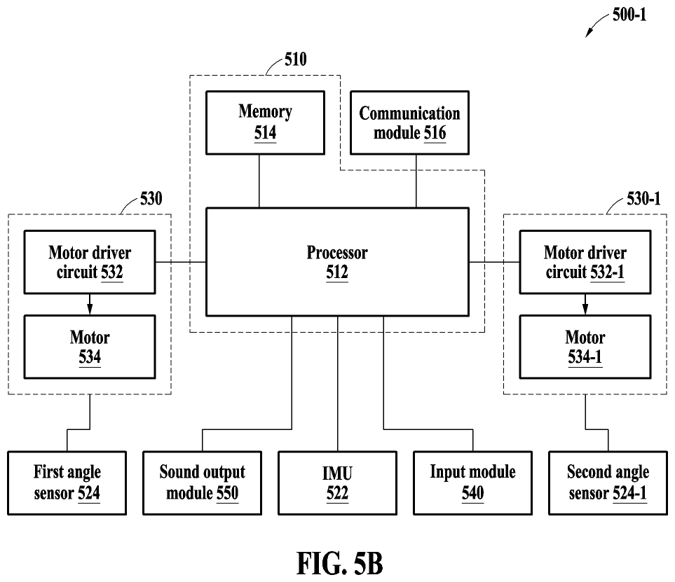

In an example embodiment, the wearable device 100 may include a support frame (e.g., leg support frames 50 and 55 and a waist support frame 20 of FIG. 3) configured to support the body of the user 110 when the wearable device 100 is worn on the body of the user 110, a sensor module (e.g., a sensor module 520 of FIG. 5A) configured to acquire sensor data including movement information about a physical movement (e.g., a movement of the legs and a movement of the upper body) of the user 110, the driving module 120 (e.g., driving modules 35 and 45 of FIG. 3) configured to generate a torque to be applied to the legs of the user 110, and a control module 130 (e.g., a control module 510 of FIGS. 5A and 5B) configured to control the wearable device 100.

The sensor module may include the angle sensor 125 and/or the IMU 135. The angle sensor 125 may measure a rotation angle of the leg support frame of the wearable device 100 corresponding to a hip joint angle value of the user 110. The rotation angle of the leg support frame measured by the angle sensor 125 may be estimated as the hip joint angle value (or a leg angle value) of the user 110. The angle sensor 125 may include, for example, an encoder and/or a Hall sensor. In an example embodiment, the angle sensor 125 may be present near a right hip joint and a left hip joint of the user 110, respectively. The IMU 135 may include an acceleration sensor and/or an angular velocity sensor and may measure a change in acceleration and/or angular velocity according to a movement of the user 110. For example, the IMU 135 may measure an upper body movement value of the user 110 corresponding to a movement value of the waist support frame (or a base body, e.g., a base body 80 of FIG. 3) of the wearable device 100. The movement value of the waist support frame measured by the IMU 135 may be estimated as the upper body movement value of the user 110.

In an example embodiment, the control module 130 and the IMU 135 may be disposed in the base body (e.g., the base body 80 of FIG. 3) of the wearable device 100. The base body may be positioned on a lumbar portion (e.g., a waist portion) of the user 110 while the wearable device 100 is worn on the user 110. The base body may be formed on or attached to the outside of the waist support frame of the wearable device 100. The base body may be provided on the lumbar portion of the user 110 to provide a cushioning feeling to the waist of the user and may support the waist of the user 110 along with the waist support frame. In an example embodiment, the control module 130 may determine a fall of the user using the IMU 135. When the user is lying on the ground due to a fall, a waist angle (e.g., an angle formed by the waist of the user and a z-axis) may be greater than a first angle (e.g., 45 degrees (°)). In response to the waist angle of the user being greater than or equal to the first angle based on a measurement result of the IMU 135, the control module 130 may determine that the user has fallen.

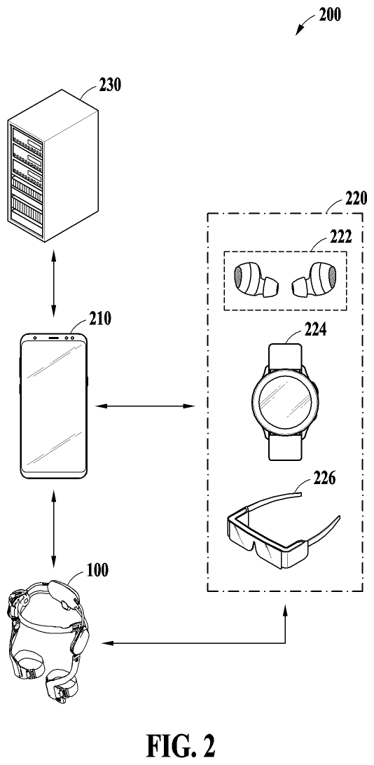

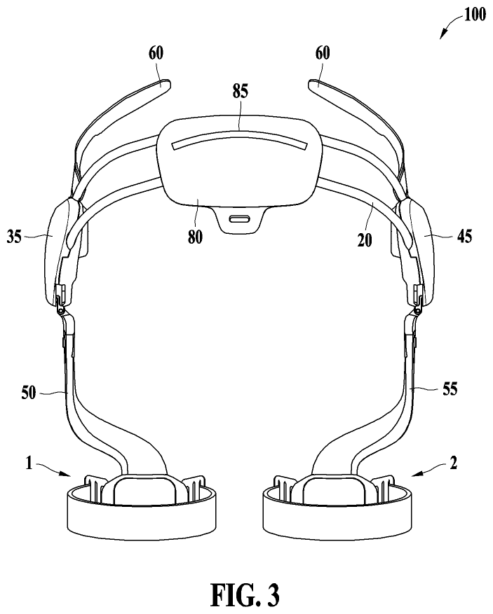

FIG. 2 is a diagram illustrating an example of an exercise management system including a wearable device and an electronic device according to an embodiment.

Referring to FIG. 2, an exercise management system 200 may include a wearable device 100 to be worn on a body of a user, an electronic device 210, another wearable device 220, and a server 230. In an example embodiment, at least one (e.g., the other wearable device 220 or the server 230) of these may be omitted from the exercise management system 200 or at least one another device (e.g., a dedicated controller device of the wearable device 100) may be added to the exercise management system 200.

In an example embodiment, the wearable device 100 may be worn on the body of the user to assist the user with their movement in a walking assistance mode. For example, the wearable device 100 may be worn on legs of the user to generate an assistance force for assisting the user with a movement of the legs and assist the user in walking.

In an example embodiment, to enhance an exercise effect on the user in an exercise assistance mode, the wearable device 100 may generate a resistance force for hindering a physical movement of the user or an assistance force for assisting a physical movement of the user, and apply the generated resistance force or the generated assistance force to the body of the user. For example, in the exercise assistance mode, the user may select, through the electronic device 210, an exercise program (e.g., squat, split lunge, dumbbell squat, knee-up lunge, stretching, etc.) with which the user attempts to do an exercise using the wearable device 100, and/or an exercise intensity to be applied to the wearable device 100. The wearable device 100 may control a driving module of the wearable device 100 according to the exercise program selected by the user and acquire sensor data including movement information of the user through a sensor module. The wearable device 100 may adjust the strength of the resistance force or the assistance force to be applied to the user according to the exercise intensity selected by the user. For example, the wearable device 100 may control the driving module to generate a resistance force corresponding to the exercise intensity selected by the user.

In an example embodiment, the wearable device 100 may be used to measure a physical ability of the user through interworking with the electronic device 210. The wearable device 100 may operate in a physical ability measurement mode which is a mode for measuring a physical ability of the user under the control of the electronic device 210 and may transmit sensor data acquired by a movement of the user in the physical ability measurement mode to the electronic device 210. The electronic device 210 may then estimate the physical ability of the user by analyzing the sensor data received from the wearable device 100.

The electronic device 210 may communicate with the wearable device 100, and remotely control the wearable device 100 or provide the user with state information associated with a state (e.g., a booting state, a charging state, a sensing state, and an error state) of the wearable device 100. The electronic device 210 may receive the sensor data acquired by a sensor of the wearable device 100 from the wearable device 100 and estimate a physical ability of the user or a result of an exercise performed by the user based on the received sensor data. In an example embodiment, when the user is doing an exercise with the wearable device 100 worn on the user, the wearable device 100 may acquire sensor data including movement information of the user using sensors and transmit the acquired sensor data to the electronic device 210. The electronic device 210 may extract a movement value of the user from the sensor data and evaluate an exercise posture of the user based on the extracted movement value.

As described below, a torque sensor may be disposed between a motor of the wearable device 100 and an output link of the wearable device 100, and the torque sensor may measure power (or force) from the user. The wearable device 100 may apply a more appropriate external force to the user based on the power measured by the torque sensor. The wearable device 100 and/or the electronic device may use the sensor data described above and the power measured by the torque sensor to coach the user on an exercise.

The electronic device 210 may provide a measured value of the exercise posture and evaluation information associated with the exercise posture to the user via a graphical user interface (GUI).

In an example embodiment, the electronic device 210 may execute a program (e.g., an application) for controlling the wearable device 100, and the user may adjust, through the program, an operation of the wearable device 100 or setting values (e.g., an intensity of a torque output from a driving module (e.g., the driving modules 35 and 45 of FIG. 3), a size of audio output from a sound output module (e.g., a sound output module 550 of FIGS. 5A and 5B), and a brightness of a lighting unit (e.g., a lighting unit 85 of FIG. 3)). The program executed on the electronic device 210 may provide a GUI for an interaction with the user. The electronic device 210 may be a device in one of various type. The electronic device 210 may include, as non-limiting examples, a portable communication device (e.g., a smartphone), a computer device, an access point, a portable multimedia device, or a consumer electronic device (e.g., a television (TV), an audio device, and a projector device). Each “driving module” herein may comprise a motor and/or driving circuitry (e.g., see FIG. 5A).

In an example embodiment, the electronic device 210 may be connected to the server 230 using short-range wireless communication or cellular communication. The server 230 may receive user profile information of the user using the wearable device 100 from the electronic device 210 and store and manage the received user profile information. The user profile information may include, for example, information about at least one of name, age, gender, height, weight, or body mass index (BMI) of the user. The server 230 may receive, from the electronic device 210, exercise history information about an exercise performed by the user, and store and manage the received exercise history information. The server 230 may provide the electronic device 210 with various exercise programs or physical ability measurement programs that may be provided to the user.

In an example embodiment, the wearable device 100 and/or the electronic device 210 may be connected to the other wearable device 220. The other wearable device 220 may include, as non-limiting examples, wireless earphones 222, a smartwatch 224, smart glasses 226, or a virtual reality (VR) device. In an example embodiment, the smartwatch 224 may measure a biosignal including heart rate information of the user and transmit the measured biosignal to the electronic device 210 and/or the wearable device 100. The electronic device 210 may estimate the heart rate information (e.g., current heart rate, maximum heart rate, and average heart rate) of the user based on the biosignal received from the smartwatch 224 and provide the estimated heart rate information to the user.

In an example embodiment, the wearable device 100 may be wired or wirelessly connected to the VR device. The VR device may display a VR environment on its display. When the VR device displays a VR exercise environment (e.g., a VR environment of walking underwater or a VR environment of walking uphill) on its display, the wearable device 100 may provide a resistance force to the user. Accordingly, the user may feel a load of walking underwater or climbing a hill in a real world in such a VR environment through the resistance force of the wearable device 100. The VR device may display a virtual avatar (e.g., an exercise coaching avatar) on its display, and the user wearing the wearable device 100 may perform the exercise while viewing the virtual avatar in the VR environment. In this case, the wearable device 100 may provide an appropriate external force (e.g., an assistance force or resistance force) to the user.

In an example embodiment, exercise result information, physical ability information, and/or exercise posture evaluation information that are evaluated by the electronic device 210 may be transferred to the other wearable device 220 to be provided to the user via the other wearable device 220. In this case, state information of the wearable device 100 may also be transferred to the other wearable device 220 to be provided to the user via the other wearable device 220. In an example embodiment, the wearable device 100, the electronic device 210, and the other wearable device 220 may be connected to each other through wireless communication (e.g., Bluetooth communication or Wi-Fi communication).

In an example embodiment, the wearable device 100 may provide (or output) feedback (e.g., visual feedback, auditory feedback, and/or tactile feedback) corresponding to a state of the wearable device 100 according to a control signal received from the electronic device 210. For example, the wearable device 100 may provide visual feedback through the lighting unit (e.g., the lighting unit 85 of FIG. 3) and auditory feedback through the sound output module (e.g., the sound output module 550 of FIGS. 5A and 5B). The wearable device 100 may include a haptic module and provide tactile feedback in the form of vibration to the body of the user via the haptic module. The electronic device 210 may also provide (or output) feedback (e.g., visual feedback, auditory feedback, and/or tactile feedback) corresponding to the state of the wearable device 100.

In an example embodiment, the electronic device 210 may present a personalized exercise goal to the user in the exercise assistance mode. The personalized exercise goal may include a target exercise amount for each exercise type (e.g., a muscle strengthening exercise (or weight exercise), a balance exercise, an aerobic exercise (or cardio exercise)) that the user attempts to do, which may be determined by the electronic device 210 and/or the server 230. When the server 230 determines the target exercise amount, the server 230 may transmit information about the determined target exercise amount to the electronic device 210. The electronic device 210 may then personalize and present a target exercise amount for an exercise type (e.g., the muscle strengthening exercise, the balance exercise, and the aerobic exercise) according to an exercise program (e.g., squat, split lunge, and knee-up lunge) the user attempts to perform and/or physical characteristics (e.g., age, height, weight, and BMI) of the user. The electronic device 210 may display, on its display, a GUI screen that displays the target exercise amount for each exercise type.

In an example embodiment, the electronic device 210 and/or the server 230 may include a database (DB) in which information about a plurality of exercise programs to be provided to the user through the wearable device 100 is stored. To achieve the exercise goal for the user, the electronic device 210 and/or the server 230 may recommend an exercise program that is suitable for the user. The exercise goal may include, for example, at least one of improving muscular strength, improving muscular physical strength, improving cardiovascular endurance, improving core stability, improving flexibility, or improving symmetry. The electronic device 210 and/or the server 230 may store and manage the exercise program performed by the user, a result of performing the exercise program, and the like.

FIG. 3 is a rear view of an example of a wearable device according to an embodiment. FIG. 4 is a left side view of an example of a wearable device according to an embodiment.

According to an example embodiment, referring to FIGS. 3 and 4, a wearable device 100 may include a base body 80, a waist support frame 20, driving modules 35 and 45, leg support frames 50 and 55, thigh fasteners 1 and 2, and a waist fastener 60. The base body 80 may include a lighting unit 85. In an example embodiment, at least one (e.g., the lighting unit 85) of these components may be omitted from or at least one other component (e.g., a haptic module) may be added to the wearable device 100.

The base body 80 may be positioned on the waist of a user while the wearable device 100 is worn on a body of the user. The base body 80 may be positioned on the waist of the user to provide a cushioning feeling to the waist of the user and support the waist of the user. The base body 80 may be hung around the buttocks of the user such that the wearable device 100 does not escape downward by gravity while the wearable device 100 is worn on the user. The base body 80 may distribute a portion of the weight of the wearable device 100 to the waist of the user while the wearable device 100 is worn on the user. The base body 80 may be connected, directly or indirectly, to the waist support frame 20. At both ends of the base body 80, a waist support frame connection element (not shown) that may be connected to the waist support frame 20 may be provided.

In an example embodiment, the lighting unit 85 may be disposed outside the base body 80. The lighting unit 85 may include a light source (e.g., a light-emitting diode (LED)). The lighting unit 85 may emit light under the control of a control module (not shown) (e.g., a control module 510 of FIGS. 5A and 5B). Depending on embodiments, the control module may control the lighting unit 85 to provide (or output) visual feedback corresponding to a state of the wearable device 100 to the user via the lighting unit 85.

The waist support frame 20 may extend from both ends of the base body 80. Inside the waist support frame 20, the waist of the user may be accommodated. The waist support frame 20 may include at least one rigid body beam. Each beam may be provided in a curved shape having a preset curvature to surround the waist of the user. The waist fastener 60 may be connected, directly or indirectly, to an end of the waist support frame 20. The driving modules 35 and 45 may be connected, directly or indirectly, to the waist support frame 20. In an example embodiment, the control module (not shown), an IMU (not shown) (e.g., the IMU 135 of FIG. 1 and an IMU 522 of FIG. 5B), a communication module (not shown) (e.g., a communication module 516 of FIGS. 5A and 5B, comprising communication circuitry), and a battery (not shown) may be disposed inside the base body 80. The base body 80 may protect the control module, the IMU, the communication module, and the battery. The control module may generate a control signal for controlling an operation of the wearable device 100. The control module may include a control circuit including a processor and a memory to control actuators of the driving modules 35 and 45. The control module may further include a power supply module (not shown) to supply power of the battery to each of the components of the wearable device 100.

In an example embodiment, the wearable device 100 may include a sensor module (not shown) (e.g., a sensor module 520 of FIG. 5A) configured to acquire sensor data from at least one sensor. The sensor module may acquire the sensor data that changes according to a movement of the user. In an example embodiment, the sensor module may acquire the sensor data including movement information of the user and/or movement information of the components of the wearable device 100. The sensor module may include, for example, an IMU (e.g., the IMU 135 of FIG. 1 or the IMU 522 of FIG. 5B) for measuring an upper body movement value of the user or a movement value of the waist support frame 20, and an angle sensor (e.g., the angle sensor 125 of FIG. 1, and a first angle sensor 524 and a second angle sensor 524-1 of FIG. 5B) for measuring a hip joint angle value of the user or a movement value of the leg support frames 50 and 55, but is not limited thereto. The sensor module may further include, for example, at least one of a position sensor, a temperature sensor, a biosignal sensor, or a proximity sensor.

The waist fastener 60 may be connected, directly or indirectly, to the waist support frame 20 to fasten the waist support frame 20 to the waist of the user. The waist fastener 60 may include, for example, a pair of belts.

The driving modules 35 and 45 may generate an external force (or torque) to be applied to the body of the user based on the control signal generated by the control module. For example, the driving modules 35 and 45 may generate an assistance force or a resistance force to be applied to the legs of the user. In an example embodiment, the driving modules 35 and 45 may include a first driving module 45 disposed at a position corresponding to a position of a right hip joint of the user and a second driving module 35 disposed at a position corresponding to a position of a left hip joint of the user. The first driving module 45 may include a first actuator and a first joint member, and the second driving module 35 may include a second actuator and a second joint member. The first actuator may provide power to be transferred to the first joint member, and the second actuator may provide power to be transferred to the second joint member. The first actuator and the second actuator may each include a motor configured to generate power (or torque) by receiving power from the battery. When powered and driven, the motor may generate a force (e.g., the assistance force) for assisting a physical movement of the user or a force (e.g., the resistance force) for hindering a physical movement of the user. In an example embodiment, the control module may adjust a voltage and/or current to be supplied to the motor to adjust the intensity and direction of the force to be generated by the motor.

In an example embodiment, the first joint member and the second joint member may receive power from the first actuator and the second actuator, respectively, and may apply an external force to the body of the user based on the received power. The first joint member and the second joint member may be disposed at corresponding positions of joint portions of the user, respectively. One side of the first joint member may be connected, directly or indirectly, to the first actuator, and the other side thereof may be connected, directly or indirectly, to a first leg support frame 55. The first joint member may be rotated by the power received from the first actuator. An encoder or a Hall sensor that may operate as the angle sensor for measuring a rotation angle (corresponding to a joint angle of the user) of the first joint member may be disposed on one side of the first joint member. One side of the second joint member may be connected to the second actuator, and the other side thereof may be connected to a second leg support frame 50. The second joint member may be rotated by the power received from the second actuator. An encoder or a Hall sensor that may operate as the angle sensor for measuring a rotation angle (corresponding to a joint angle of the user) of the second joint member may also be disposed on one side of the second joint member. “Disposed on” as used herein covers disposed directly on and disposed indirectly on.

In an example embodiment, the first actuator may be disposed in a lateral direction of the first joint member, and the second actuator may be disposed in a lateral direction of the second joint member. A rotation axis of the first actuator and a rotation axis of the first joint member may be disposed to be separate from each other, and a rotation axis of the second actuator and a rotation axis of the second joint member may also be disposed to be separate from each other. However, embodiments are not limited thereto, and each actuator and each joint member may share a rotation axis. In an example embodiment, each actuator may be disposed to be separate from each joint member. In this case, the driving modules 35 and 45 may further include a power transmission module (not shown) configured to transfer power from the respective actuators to the respective joint members. The power transmission module may be a rotary body (e.g., a gear), or a longitudinal member (e.g., a wire, a cable, a string, a spring, a belt, or a chain). However, the scope of examples is not limited to the preceding positional relationship between the actuators and the joint members, and the preceding power transmission structure.

In an example embodiment, the leg support frames 50 and 55 may support the legs (e.g., thighs) of the user when the wearable device 100 is worn on the legs of the user. For example, the leg support frames 50 and 55 may transfer power (e.g., torque) generated by the driving modules 35 and 45 to the thighs of the user, and the power may act as an external force to be applied to a movement of the legs of the user. As one end of the leg support frames 50 and 55 is connected, directly or indirectly, to a joint member to be rotated and the other end of the leg support frames 50 and 55 is connected, directly or indirectly, to thigh fasteners 1 and 2, the leg support frames 50 and 55 may transfer the power generated by the driving modules 35 and 45 to the thighs of the user while supporting the thighs of the user. For example, the leg support frames 50 and 55 may push or pull the thighs of the user. The leg support frames 50 and 55 may extend in a longitudinal direction of the thighs of the user. The leg support frames 50 and 55 may be bent to wrap at least a portion of the circumference of the thighs of the user. The leg support frames 50 and 55 may include the first leg support frame 55 for supporting the right leg of the user and the second leg support frame 50 for supporting the left leg of the user.

In an example embodiment, the wearable device 100 may further include first and second output links (not shown) and first and second torque sensor modules (not shown).

In an example embodiment, the first output link may be disposed between the first driving module 45 and the first leg support frame 55. One end of the first output link may be connected, directly or indirectly, to the first driving module 45, and the other end of the first output link may be connected, directly or indirectly, to the first leg support frame 55. In this case, power generated by the first driving module 45 may be transferred to the first leg support frame 55 via the first output link. The first torque sensor module may be disposed on, directly or indirectly, the first output link. The first torque sensor module may be integral with the first output link. The first torque sensor module may generate torque data by measuring a torque caused by at least one of a movement of the right leg of the user or an operation of the first driving module 45.

In an example embodiment, the second output link may be disposed between the second driving module 35 and the second leg support frame 50. One end of the second output link may be connected to the second driving module 35, and the other end of the second output link may be connected to the second leg support frame 50. In this case, power generated by the second driving module 35 may be transferred to the second leg support frame 50 via the second output link. The second torque sensor module may be disposed on, directly or indirectly, the second output link. The second torque sensor module may be integral with the second output link. The second torque sensor module may generate torque data by measuring a torque caused by at least one of a movement of the left leg of the user or an operation of the second driving module 35.

In an example embodiment, the wearable device 100 may include a first wireless power transmitter, a first wireless power receiver, a second wireless power transmitter, and a second wireless power receiver. For example, the first wireless power transmitter may be disposed in the first driving module 45, and the first wireless power receiver may be disposed on the first output link. The first wireless power transmitter may transmit wireless power to the first wireless power receiver. The first wireless power receiver may convert the wireless power and supply the converted wireless power to a component (e.g., the first torque sensor module, etc.) disposed in the first output link. The first wireless power receiver may transmit the torque data of the first torque sensor module to the first wireless power transmitter through wireless communication. The first wireless power transmitter may transfer the torque data to a processor of a control system via the first driving module 45 or transmit the torque data directly to the processor of the control system without passing through the first driving module 45.

For example, the second wireless power transmitter may be disposed in the second driving module 35, and the second wireless power receiver may be disposed on the second output link. The second wireless power transmitter may transmit wireless power to the second wireless power receiver. The second wireless power receiver may convert the wireless power and supply the converted wireless power to a component (e.g., the second torque sensor module, etc.) disposed in the second output link. The second wireless power receiver may transmit the torque data of the second torque sensor module to the second wireless power transmitter through wireless communication. The second wireless power transmitter may transfer the torque data to the processor of the control system via the second driving module 35 or transmit the torque data directly to the processor of the control system without passing through the second driving module 35.

The thigh fasteners 1 and 2 may be connected, directly or indirectly, to the leg support frames 50 and 55 and may fix the leg support frames 50 and 55 to the thighs of the user. The thigh fasteners 1 and 2 may include a first thigh fastener 2 for fixing the first leg support frame 55 to the right thigh of the user, and a second thigh fastener 1 for fixing the second leg support frame 50 to the left thigh of the user.

In an example embodiment, the first thigh fastener 2 may include a first cover, a first fastening frame, and a first strap. The second thigh fastener 1 may include a second cover, a second fastening frame, and a second strap. The first cover and the second cover may apply a torque generated by the driving modules 35 and 45 to the thighs of the user. The first cover and the second cover may be disposed on one side of the thighs of the user to push or pull the thighs of the user. The first cover and the second cover may be disposed on a front surface of the thighs of the user. The first cover and the second cover may be disposed along a circumferential direction of the thighs of the user. The first cover and the second cover may extend to both sides around the other ends of the leg support frames 50 and 55 and may include curved surfaces corresponding to the thighs of the user. One ends of the first cover and the second cover may be connected, directly or indirectly, to corresponding fastening frames, and the other ends thereof may be connected, directly or indirectly, to corresponding straps.

For example, the first fastening frame and the second fastening frame may be disposed to surround at least a portion of the circumference of the thighs of the user to prevent the thighs of the user from escaping from the leg support frames 50 and 55. The first fastening frame may have a fastening structure that connects the first cover and the first strap, and the second fastening frame may have a fastening structure that connects the second cover and the second strap.

The first strap may surround a remaining portion of the circumference of the right thigh of the user that is not covered by the first cover and the first fastening frame, and the second strap may surround a remaining portion of the circumference of the left thigh of the user that is not covered by the second cover and the second fastening frame. The first strap and the second strap may each include, for example, an elastic material (e.g., a band).

FIGS. 5A and 5B are diagrams illustrating example configurations of a control system of a wearable device according to an embodiment.

Referring to FIG. 5A, the wearable device 100 may be controlled by a control system 500. The control system 500 may include a control module 510, a communication module 516 comprising communication circuitry, a sensor module 520, a driving module 530, an input module 540, and a sound output module 550. In an example embodiment, at least one (e.g., the sound output module 550) of these components may be omitted from or at least one other component (e.g., a haptic module) may be added to the control system 500.

The driving module 530 may include a motor 534 configured to generate power (e.g., torque) and a motor driver circuit 532 configured to drive the motor 534. Although a driving module (e.g., the driving module 530) is illustrated as including a single motor driver circuit (e.g., the motor driver circuit 532) and a single motor (e.g., the motor 534) in FIG. 5A, examples of which are not limited thereto. For example, as shown in FIG. 5B, a driving module (e.g., a driving module 530-1) of a control system 500-1 may include a plurality of (e.g., two or more) motor driver circuits (e.g., motor driver circuits 532 and 532-1) and motors (e.g., motors 534 and 534-1). The driving module 530 including the motor driver circuit 532 and the motor 534 may correspond to the first driving module 45 of FIG. 3, and the driving module 530-1 including the motor driver circuit 532-1 and the motor 534-1 may correspond to the second driving module 35 of FIG. 3. The following description of the motor driver circuit 532 and the motor 534 may also apply to the motor driver circuit 532-1 and the motor 534-1 shown in FIG. 5B.

Referring back to FIG. 5A, the sensor module 520 may include a sensor circuit including at least one sensor. The sensor module 520 may acquire sensor data including movement information of a user or movement information of the wearable device 100. The sensor module 520 may transfer the acquired sensor data to the control module 510. The sensor module 520 may include an IMU 522. The IMU 522 may measure an upper body movement value of the user. For example, the IMU 522 may sense X-axis, Y-axis, and Z-axis acceleration, and sense X-axis, Y-axis, and Z-axis angular velocity according to a movement of the user. The IMU 522 may be used to measure at least one of, for example, a forward and backward tilt, a leftward and rightward tilt, or a rotation of the body of the user. In addition, the IMU 522 may acquire a movement value (e.g., an acceleration value and an angular velocity value) of a waist support frame (e.g., the waist support frame 20 of FIG. 3) of the wearable device. The movement value of the waist support frame may correspond to the upper body movement value of the user.

In an example embodiment, the sensor module 520 may further include at least one of a position sensor for acquiring a position value of the wearable device 100, a proximity sensor for detecting proximity of an object, a biosignal sensor for detecting a biosignal of the user, or a temperature sensor for measuring an ambient temperature.

The input module 540 may receive a command or data to be used by a component (e.g., a processor 512) of the wearable device 100 from the outside (e.g., the user) of the wearable device 100. The input module 540 may include an input component circuit. The input module 540 may include, for example, a key (e.g., a button) or a touchscreen.

The sound output module 550 may output a sound signal to the outside of the wearable device 100. The sound output module 550 may provide auditory feedback to the user. For example, the sound output module 550 may include a speaker that reproduces a guide voice for an audible notification of a guide sound signal (e.g., a driving start sound, a posture error notification sound, or an exercise start notification sound), music content, or specific information (e.g., exercise result information and exercise posture evaluation information).

In an example embodiment, the control system 500 may further include a battery (not shown) for supplying power to each component of the wearable device 100. The wearable device may convert power of the battery according to an operating voltage of each component of the wearable device and supply the converted power to each component.

The driving module 530 may generate an external force to be applied to the legs of the user under the control of the control module 510. The driving module 530 may generate a torque to be applied to the legs of the user based on a control signal generated by the control module 510. The control module 510 may transmit the control signal to the motor driver circuit 532. The motor driver circuit 532 may control an operation of the motor 534 by generating a current signal (or a voltage signal) corresponding to the control signal and supplying the generated current signal to the motor 534. As circumstances require, the current signal may not be supplied to the motor 534. For example, the motor driver circuit 532 may not supply the current signal to the motor 534 under the control of the processor 512. When the motor 534 is driven as the current signal is supplied to the motor 534, the motor 534 may generate a torque for an assistance force for assisting a movement of the legs of the user or a resistance force for hindering a movement of the legs of the user. Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

An angle sensor (e.g., a first angle sensor 524 and a second angle sensor 524-1) may measure a joint angle value (e.g., a hip joint angle value according to a movement of the legs of the user). For example, the first angle sensor 524 of FIG. 5B may acquire a hip joint angle value (or hip joint angle data) of the right leg of the user, and the second angle sensor 524-1 may acquire a hip joint angle value (or hip joint angle data) of the left leg of the user. The joint angle data acquired by the first angle sensor 524 may be transferred to the processor 512 via the driving module 530 (e.g., a microcontroller unit (MCU) in the driving module 530), and sensor data measured by the second angle sensor 524-1 may be transferred to the processor 512 via the driving module 530-1 (e.g., an MCU in the driving module 530-1). However, embodiments are not limited thereto, and the joint angle data acquired by the first angle sensor 524 may be transmitted directly to the processor 512, and the joint angle data acquired by the second angle sensor 524-1 may be transmitted directly to the processor 512. The first angle sensor 524 and the second angle sensor 524-1 may each include an encoder and/or a Hall sensor, for example. The angle sensor may also acquire a movement value of a leg support frame of the wearable device. For example, the first angle sensor 520 may acquire a movement value of the first leg support frame 55, and the second angle sensor 520-1 may acquire a movement value of the second leg support frame 50. The movement value of the leg support frame may correspond to the hip joint angle value.

The control module 510 may control an overall operation of the wearable device and may generate a control signal for controlling each component (e.g., the communication module 516 and the driving module 530). The control module 510 may include the processor 512 and a memory 514.

For example, the processor 512 may execute software to control at least one other component (e.g., a hardware or software component) of the wearable device connected to the processor 512 and may perform various types of data processing or computation. The software may include an application for providing a GUI. In an example embodiment, as at least a part of data processing or computation, the processor 512 may store instructions or data received from another component (e.g., the communication module 516) in the memory 514, process the instructions or data stored in the memory 514, and store resulting data acquired by the processing in the memory 514. In an example embodiment, the processor 512 may include, for example, a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently of, or in conjunction with, the main processor. The auxiliary processor may be implemented separately from the main processor or as a part of the main processor.

The memory 514 may store various pieces of data used by at least one component (e.g., the processor 512) of the control module 510. The data may include, for example, input data or output data for software, sensor data, and instructions related thereto. The memory 514 may include a volatile memory or a non-volatile memory (e.g., a random-access memory (RAM), a dynamic RAM (DRAM), or a static RAM (SRAM)).

The communication module 516 may support establishment of a direct (e.g., wired) communication channel or a wireless communication channel between the control module 510 and another component of the wearable device 100 or an external electronic device (e.g., the electronic device 210 or the other wearable device 220 of FIG. 2), and support communication through the established communication channel. The communication module 516 may include a communication circuit for performing a communication function. For example, the communication module 516 may receive a control signal from an electronic device (e.g., the electronic device 210) and transmit the sensor data acquired by the sensor module 520 to the electronic device. In an example embodiment, the communication module 516 may include at least one CP (not shown) that is operable independently of the processor 512 and that supports the direct (e.g., wired) communication or the wireless communication. In an example embodiment, the communication module 516 may include a wireless communication module (e.g., a cellular communication module, a short-range wireless communication module, or a global navigation satellite system (GNSS) communication module), and/or a wired communication module. A corresponding one of these communication modules may communicate with another component of the wearable device 100 and/or the external electronic device via a short-range communication network (e.g., Bluetooth™, wireless-fidelity (Wi-Fi), or infrared data association (IrDA)), or a long-range communication network (e.g., a legacy cellular network, a fifth-generation (5G) network, a next-generation communication network, the Internet, or a computer network (e.g., a local area network (LAN) or a wide area network (WAN)).

In an example embodiment, the control system (e.g., the control systems 500 and 500-1) may further include a haptic module (not shown). The haptic module may provide tactile feedback to the user under the control of the processor 512. The haptic module may convert an electrical signal into a mechanical stimulus (e.g., a vibration or a movement) or an electrical stimulus that may be recognized by the user via their tactile sensation or kinesthetic sensation. The haptic module may include, for example, a motor, a piezoelectric element, or an electrical stimulation device. In an example embodiment, the haptic module may be disposed in at least one of a base body (e.g., the base body 80), a first thigh fastener (e.g., the first thigh fastener 2), or a second thigh fastener (e.g., the second thigh fastener 1).

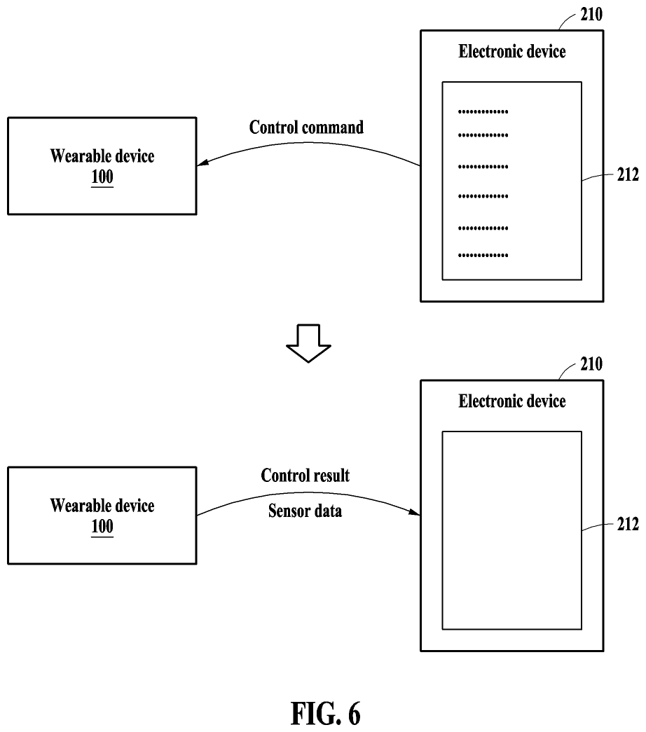

FIG. 6 is a diagram illustrating an example of an interaction between a wearable device and an electronic device according to an embodiment.

Referring to FIG. 6, the wearable device 100 may communicate with the electronic device 210. For example, the electronic device 210 may be a user terminal of a user who uses the wearable device 100, or a dedicated controller for the wearable device 100. In an example embodiment, the wearable device 100 and the electronic device 210 may be connected to each other through short-range wireless communication (e.g., Bluetooth communication or Wi-Fi communication).

In an example embodiment, the electronic device 210 may execute an application for checking a state of the wearable device 100 or for controlling or operating the wearable device 100. When the application is executed, a screen of a user interface (UI) for controlling an operation of the wearable device 100 or determining an operating mode of the wearable device 100 may be displayed on a display 212 of the electronic device 210. The UI may be a GUI, for example.

In an example embodiment, the user may input a command (e.g., a command for executing a walking assistance mode, an exercise assistance mode, or a physical ability measurement mode) for controlling the operation of the wearable device 100 or change settings of the wearable device 100, through the screen of the GUI on the display 212 of the electronic device 210. The electronic device 210 may generate a control command (or a control signal) corresponding to an operation control command or a settings change command that is input by the user and transmit the generated control command to the wearable device 100. The wearable device 100 may operate according to the received control command and may transmit, to the electronic device 210, a control result acquired in response to the control command and/or sensor data measured by a sensor module of the wearable device 100. The electronic device 210 may provide, to the user through the screen of the GUI, resulting information (e.g., walking ability information, exercise ability information, and exercise posture evaluation information) derived by analyzing the control result and/or the sensor data.

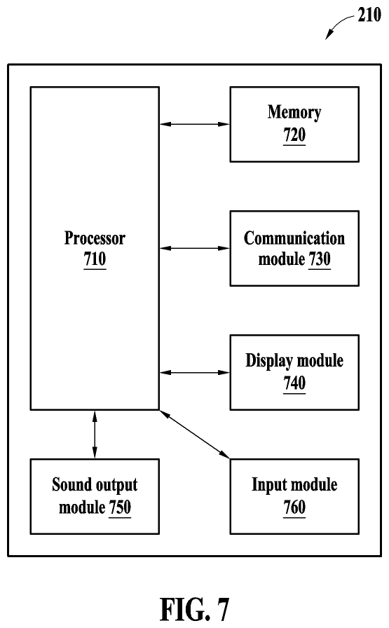

FIG. 7 is a diagram illustrating an example configuration of an electronic device according to an embodiment.

Referring to FIG. 7, the electronic device 210 may include a processor 710, a memory 720, a communication module 730, a display module 740, a sound output module 750, and an input module 760. In an example embodiment, at least one (e.g., the sound output module 750) of these components may be omitted from or at least one other component (e.g., a sensor module and a battery) may be added to the electronic device 210.

The processor 710 may control at least one other component (e.g., a hardware or software component) of the electronic device 210 and may perform various types of data processing or computation. In an example embodiment, as at least a part of data processing or computation, the processor 710 may store instructions or data received from another component (e.g., the communication module 730) in the memory 720, process the instructions or data stored in the memory 720, and store resulting data in the memory 720.

In an example embodiment, the processor 710 may include, for example, a main processor (e.g., a CPU or an AP) or an auxiliary processor (e.g., a GPU, an NPU, an ISP, a sensor hub processor, or a CP) that is operable independently of, or in conjunction with, the main processor.

The memory 720 may store various pieces of data used by at least one component (e.g., the processor 710 or the communication module 730) of the electronic device 210. The data may include, for example, input data or output data for a program (e.g., an application) and instructions related thereto. The memory 720 may include at least one instruction executable by the processor 710. The memory 720 may include a volatile memory or a non-volatile memory.

The communication module 730 may support the establishment of a direct (e.g., wired) communication channel or a wireless communication channel between the electronic device 210 and another electronic device (e.g., the wearable device 100, the other wearable device 220, and the server 230), and support the communication via the established communication channel. The communication module 730 may include a communication circuit for performing a communication function. The communication module 730 may include at least one communication processor (CP) that is operable independently of the processor 710 (e.g., an AP) and support direct (e.g., wired) communication or wireless communication. In an example embodiment, the communication module 730 may include a wireless communication module (e.g., a Bluetooth communication module, a cellular communication module, a Wi-Fi communication module, or a GNSS communication module) or a wired communication module (e.g., a LAN communication module or a power line communication module). For example, the communication module 730 may transmit a control command to the wearable device 100 and receive at least one of sensor data including physical movement information of a user wearing the wearable device 100, state data of the wearable device 100, or control result data corresponding to the control command.

The display module 740 may visually provide information to the outside (e.g., the user) of the electronic device 210. The display module 740 may include, for example, a liquid-crystal display (LCD) or an organic light-emitting diode (OLED) display, a hologram device, or a projector device. The display module 740 may further include a control circuit for controlling the driving of a display. In an example embodiment, the display module 740 may include a touch sensor configured to sense a touch, or a pressure sensor configured to measure an intensity of a force incurred by the touch.

The sound output module 750 may output a sound signal to the outside of the electronic device 210. The sound output module 750 may include a speaker that reproduces a guide sound signal (e.g., a driving start sound and an operation error notification sound), music content, or a guide voice, based on a state of the wearable device 100. For example, in response to a determination that the wearable device 100 is not correctly worn on the body of the user, the sound output module 750 may output a guide voice to inform the user of the incorrect wearing or guide the user through normal wearing. For example, the sound output module 750 may output a guide voice corresponding to exercise evaluation information or exercise result information that is acquired by evaluating an exercise performed by the user.

The input module 760 may receive a command or data to be used by a component (e.g., the processor 710) of the electronic device 210 from the outside (e.g., the user) of the electronic device 210. The input module 760 may include an input component circuit and receive a user input from the user. The input module 760 may include, for example, a key (e.g., a button) or a touchscreen.

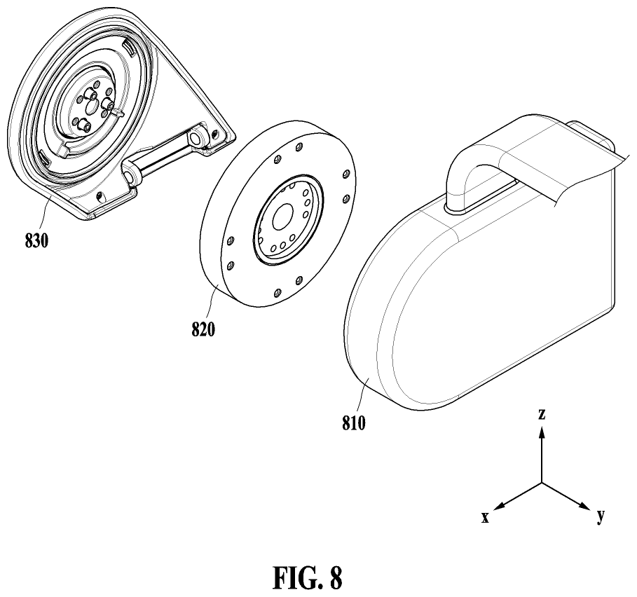

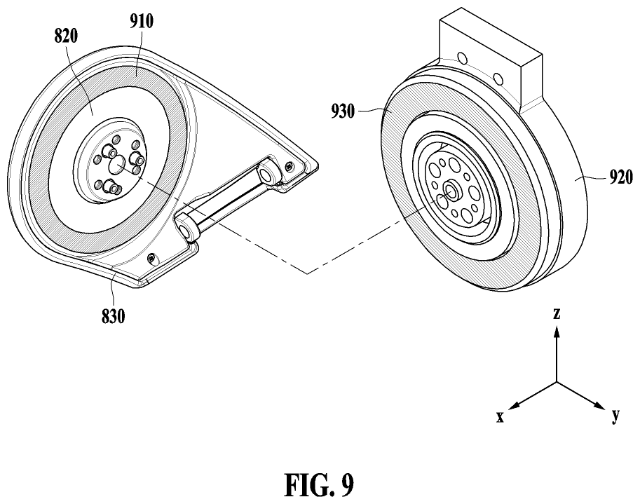

FIGS. 8 through 10B are diagrams illustrating examples of a driving module, a torque sensor, and an output link of a wearable device according to an embodiment.

Referring to FIG. 8, shown are a driving module 810, a torque sensor module 820, and an output link 830.

The driving module 810 may be an example of each of the first driving module 45 and the second driving module 35 of FIG. 3.

The torque sensor module 820 may be an example of each of the first torque sensor module and the second torque sensor module described above with reference to FIG. 3. The description of the torque sensor module 820 may thus apply to each of the first torque sensor module and the second torque sensor module.

The output link 830 may be an example of each of the first output link and the second output link described above with reference to FIG. 3. The description of the output link 830 may thus apply to each of the first output link and the second output link.

In an example embodiment, the torque sensor module 820 may generate torque data by measuring a torque that may be caused by at least one of a movement of a user or an operation of the driving module 810. For example, the torque may be generated by the operation of the driving module 810. Additionally, the user may move in a situation where an external force (e.g., an assistance force or a resistance force) is provided to the user, and the torque may be generated by the movement (e.g., hip joint rotation) of the user. The torque generated by the driving module 810 and/or the torque generated by the movement of the user may generate a strain on a rotation axis of the torque sensor module 820 (or a motor). The torque sensor module 820 may acquire or generate the torque data by detecting or measuring the generated strain.

In an example embodiment, the torque sensor module 820 may be included in the output link 830. The torque sensor module 820 may be integral (or integrated) with the output link 830.

In an example embodiment, one end of the output link 830 may be connected to the driving module 810, and the other end of the output link 830 may be connected to a support frame (e.g., the second leg support frame 50 or the first leg support frame 55 of FIG. 3). The support frame connected to the output link 830 may receive power generated by the driving module 810 via the output link 830 and may provide the received power to a body (e.g., thighs) of the user.

In an example embodiment, the wearable device 100 may include a wireless power transmitter (not shown) and a wireless power receiver (not shown). The wireless power transmitter may transmit wireless power to the wireless power receiver. The wireless power receiver may convert (e.g., rectify and/or step down) the received wireless power and may supply the converted wireless power to the torque sensor module 820.

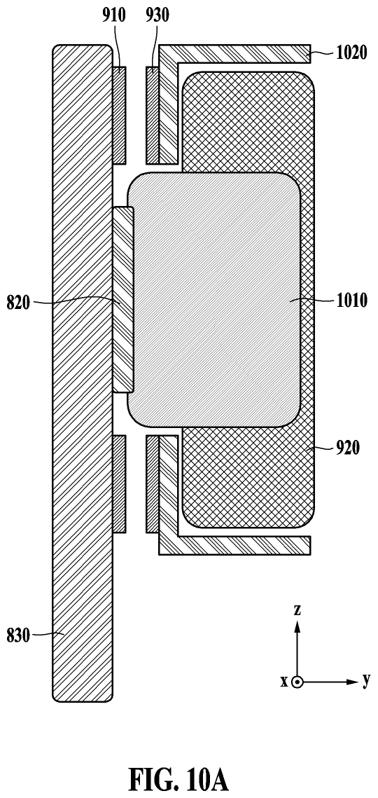

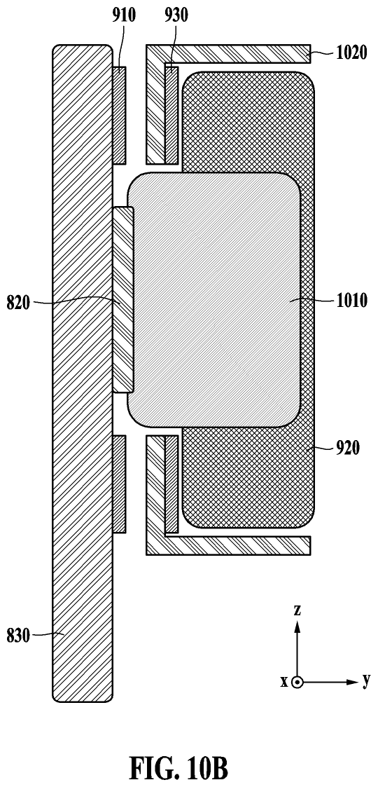

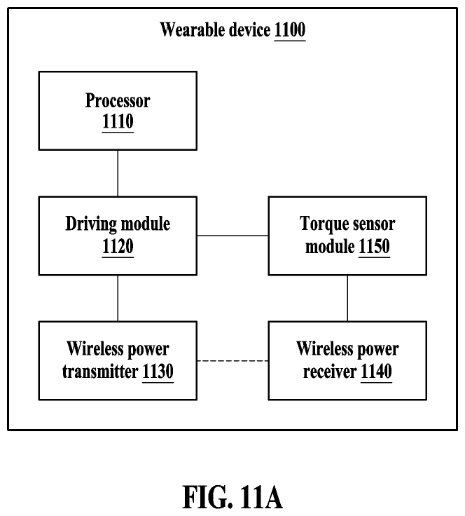

In an example embodiment, at least a portion (e.g., a receive (RX) integrated circuit (IC) (RX IC) and a direct current to direct current (DC-DC) converter) of the wireless power receiver may be disposed inside a body of the output link 830. The remaining portion (e.g., a receiving coil) of the wireless power receiver may be disposed on a first surface of the output link 830. For example, in an example shown in FIGS. 9 and 10A, a receiving coil 910 of the wireless power receiver may be disposed on the first surface of the output link 830.

In the example shown in FIGS. 9 and 10A, a motor 920 (e.g., the motor 534 or the motor 534-1 of FIG. 5B) of the driving module 810 may be disposed inside a housing 1020 (or an injection member), and a transmitting coil 930 of the wireless power transmitter may be disposed outside the housing 1020. However, examples are not limited thereto, and the transmitting coil 930 may also be disposed inside the housing 1020, such as in the example shown in FIG. 10B. Inside the housing 1020, other components (e.g., a transmit (TX) IC (TX IC)) of the wireless power transmitter may further be disposed. The wireless power transmitter, the motor 920, and the like disposed in the housing may be waterproofed by the housing.

In an example embodiment, when the torque sensor module 820 (or the output link 830) is connected to the driving module 810, the transmitting coil 930 and the receiving coil 910 may face each other. In this case, as long as the torque sensor module 820 (or the output link 830) does not escape from the driving module 810, an alignment between the transmitting coil 930 and the receiving coil 910 may be maintained.

In an example embodiment, the torque sensor module 820 (or the output link 830) may be connected to a gear 1010. The gear 1010 may convert (e.g., decelerate) an output torque of the motor 920. The output link 830 may be rotated by the converted output torque. Even as the output link 830 is rotated, the alignment between the receiving coil 910 and the transmitting coil 930 may be maintained. When an alternating current (AC) flows in the transmitting coil 930, the transmitting coil 930 may generate an electromagnetic field. The electromagnetic field may generate an induced electromotive force in the receiving coil 910. Accordingly, the transmitting coil 930 may transmit wireless power to the receiving coil 910.

Although the receiving coil 910 is shown as being disposed outside the output link 830 in the example shown in FIGS. 9, and 10A and 10B, it is provided only as an example, and the receiving coil 910 may also be disposed inside the body of the output link 830.

When the torque sensor module 820 does not receive power wirelessly but receives power by wires, and torque data from the torque sensor module 820 is transmitted and received by wires rather than wirelessly, the rotation of the motor may entangle the wires of the torque sensor module 820. To solve this problem, a hollow motor having holes may be used. The wires may be connected to the torque sensor module 820 through the holes of the hollow motor. However, the holes of the hollow motor may increase the volume of a driving module, which may make it difficult to downsize a wearable device. Further, the weight of the wires and connectors may make it difficult to lighten the weight of the wearable device. In an example embodiment, the torque sensor module 820 may receive power wirelessly and transmit the torque data wirelessly. The wearable device 100 may not include a wire used to transmit and receive the torque data, a power cable to supply power to the torque sensor module 820, and a connector for the torque sensor module 820, but may include a motor that is less in volume than the hollow motor, thereby achieving lightweighting and downsizing.

In an example embodiment, the transmitting coil 930 for wireless power transmission and the receiving coil 910 for wireless power reception may be fixed in the wearable device 100, and thus a misalignment between the transmitting coil 930 and the receiving coil 910 may not occur, and a distance between the transmitting coil 930 and the receiving coil 910 may remain constant. Accordingly, the wireless power transmitter and the wireless power receiver in the wearable device 100 may perform a simplified wireless charging protocol and may verify wireless power communication compatibility through a simple procedure.

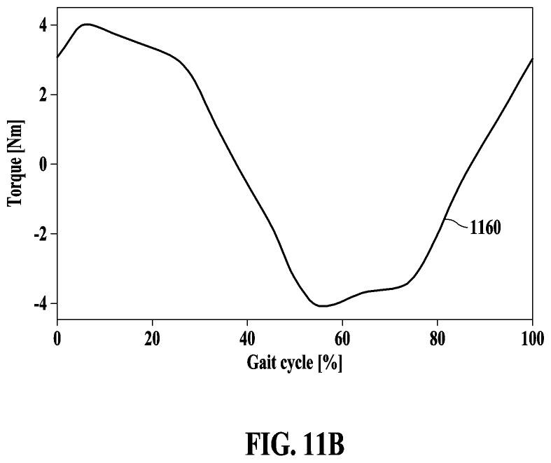

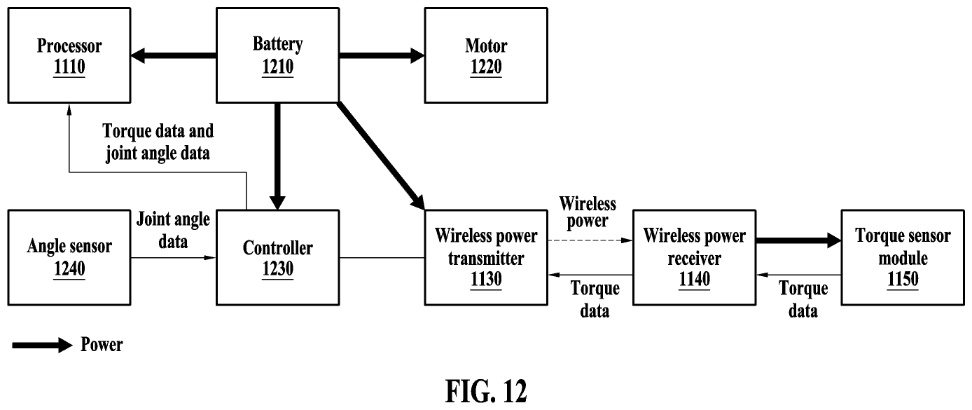

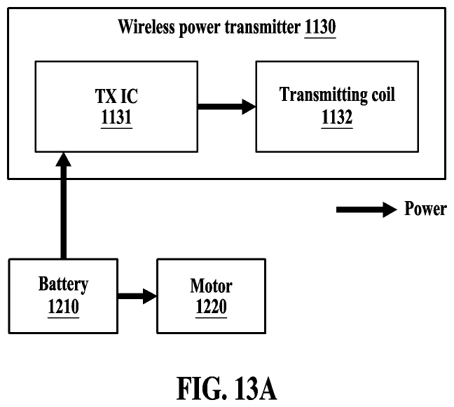

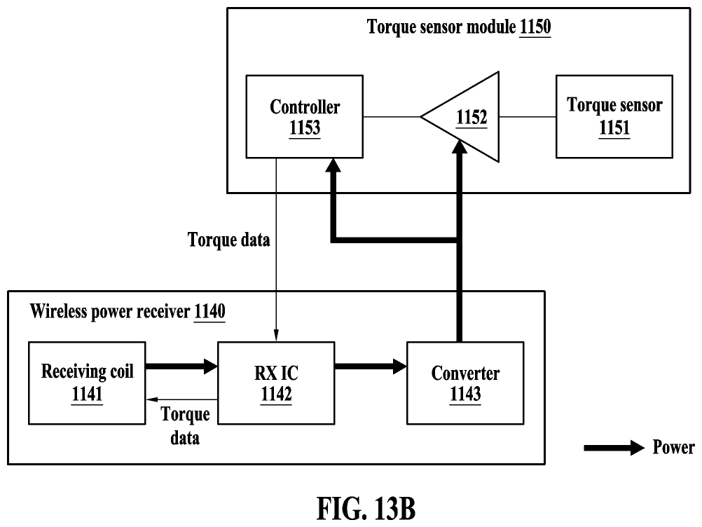

FIGS. 11A through 13B are block diagrams illustrating example configurations of a wearable device according to an embodiment.

Referring to FIG. 11A, a wearable device 1100 (e.g., the wearable device 100) may include a processor 1110 (e.g., the processor 512), a driving module 1120 (e.g., the driving module 810), a wireless power transmitter 1130, a wireless power receiver 1140, and a torque sensor module 1150 (e.g., the torque sensor module 820).

The driving module 1120 may be an example of each of the first driving module 45 and the second driving module 35 of FIG. 3. The description of the driving module 1120 may apply to each of the first driving module 45 and the second driving module 35.

The wireless power transmitter 1130 may be an example of each of the first wireless power transmitter and the second wireless power transmitter described above with reference to FIG. 3. The description of the wireless power transmitter 1130 may apply to each of the first wireless power transmitter and the second wireless power transmitter.

The wireless power receiver 1140 may be an example of each of the first wireless power receiver and the second wireless power receiver described above with reference to FIG. 3. The description of the wireless power receiver 1140 may apply to each of the first wireless power receiver and the second wireless power receiver.

The torque sensor module 1150 may be an example of each of the first torque sensor module and the second torque sensor module described above with reference to FIG. 3. The description of the torque sensor module 1150 may apply to each of the first torque sensor module and the second torque sensor module.

The processor 1110 may control the overall operation of the wearable device 1100.

In an example embodiment, the processor 1110 may acquire, using the torque sensor module 1150, a measured value of a torque generated as a user wearing the wearable device 1100 moves during multiple gait cycles in a first state where power is not supplied to a motor (e.g., the motor 920) in the driving module 1120. The processor 1110 may determine a trajectory of a torque of the user during one gait cycle, using a measured value of a torque during each gait cycle. An example of the determined trajectory (e.g., a trajectory 1160) is shown in FIG. 11B. The processor 1110 may determine the trajectory 1160 as reference information on which a torque output of the driving module 1120 is based.

In an example embodiment, the processor 1110 may allow the motor (e.g., the motor 920) to be in a second state where power is supplied to the motor in the driving module 1120. In the second state, the processor 1110 may calculate (or determine) a torque value of the driving module 1120 based on the determined reference information (e.g., the trajectory 1160 of FIG. 11B). For example, the processor 1110 may determine a torque value of a torque to be generated by the driving module 1120 such that the torque value is proportional to the determined reference information. For another example, the processor 1110 may determine the torque value of the torque to be generated by the driving module 1120 by adding a constant value to the determined reference information. The processor 1110 may control the driving module 1120 such that the driving module 1120 generates the torque corresponding to the determined torque value. As the driving module 1120 generates the torque under this control, the user may receive an optimized external force. The user may also receive an external force synchronized with a movement of the user.

In an example embodiment, the torque sensor module 1150 may generate torque data by measuring a torque caused by at least one of an operation of the driving module 1120 or a movement of the user.

In an example embodiment, the wireless power transmitter 1130 may communicate with the driving module 1120 and/or the processor 1110.

In an example embodiment, the wireless power transmitter 1130 may perform wireless power transmission. The wireless power transmitter 1130 may transmit wireless power to the wireless power receiver 1140.

In an example embodiment, the wireless power receiver 1140 may receive the wireless power from the wireless power transmitter. The wireless power receiver 1140 may convert the received wireless power and may supply the converted wireless power to the torque sensor module 1150.

In an example embodiment, the wireless power receiver 1140 may receive the torque data from the torque sensor module 1150 and transmit the torque data to the wireless power transmitter 1130.

In an example embodiment, the wireless power transmitter 1130 and the wireless power receiver 1140 may operate in accordance with a wireless charging standard, e.g., the Qi standard. In accordance with the Qi standard, the wireless power transmitter 1130 may transmit wireless power to the wireless power receiver 1140. In accordance with the Qi standard, the wireless power transmitter 1130 and the wireless power receiver 1140 may transmit and receive data. The wireless charging standard is not limited to the Qi standard described above as an example.

In an example embodiment, the wireless power transmitter 1130 and the wireless power receiver 1140 may not perform some of the operations stated in the Qi standard. In the wearable device 1100, the wireless power receiver 1140 may remain at a certain distance from the wireless power transmitter 1130. In other words, the distance between a transmitting coil 1132 and a receiving coil 1141 may remain constant. The wireless power transmitter 1130 may not perform, for example, an RX detection operation of the Qi standard. The wireless power transmitter 1130 and/or the wireless power receiver 1140 may not perform, for example, a foreign object detection (FOD) operation of the Qi standard. The wireless power transmitter 1130 may not perform, for example, an operation of identifying the wireless power receiver 1140. For example, the wireless power receiver 1140 may not transmit, to the wireless power transmitter 1130, information about the strength of a signal (e.g., a ping signal, etc.) transmitted from the wireless power transmitter 1130. As described below, an output voltage of the wireless power receiver 1140 may be constant as, for example, a first voltage (e.g., 5 volts (V)). For example, the wireless power transmitter 1130 and/or the wireless power receiver 1140 may not perform any operations for adjusting the output voltage of the wireless power receiver 1140. Some of the operations described as not being performed are provided as examples, and at least one or all of the operations described as not being performed may be performed depending on the implementation.

In an example embodiment, the processor 1110 may communicate with the driving module 1120. The processor 1110 may receive the torque data from the wireless power transmitter 1130 via the driving module 1120. The wireless power transmitter 1130 may transmit the torque data to the driving module 1120, and the driving module 1120 may transmit the torque data to the processor 1110. However, embodiments are not limited thereto, but the processor 1110 may communicate directly with the wireless power transmitter 1130 to receive the torque data from the wireless power transmitter 1130.

In an example embodiment, the processor 1110 may evaluate the movement of the user, using the torque data from the torque sensor module 1150. For example, when a difference between a value of the torque data and a value of a torque generated by the driving module 1120 (or a difference between the value of the torque data and the torque value determined by the processor 1110 described above) is less than or equal to a certain level, the processor 1110 may determine that the user is using an appropriate force for the movement and may then evaluate a state of the movement of the user as a first state (e.g., good). When the difference between the value of the torque data and the value of the torque generated by the driving module 1120 (or the difference between the value of the torque data and the torque value determined by the processor 1110 described above) exceeds the certain level, the processor 1110 may determine that the user is not using an appropriate force for the movement and may then evaluate the state of the movement of the user as a second state (e.g., bad). The processor 1110 may transmit an evaluation result, which is a result acquired by the evaluation, to the electronic device 210 via the communication module 516. The electronic device 210 may display the evaluation result on a display.

In an example embodiment, referring to FIG. 12, the wearable device 1100 may include a battery 1210, and the driving module 1120 may include, for example, a motor 1220, a controller 1230 (e.g., MCU), and an angle sensor 1240. Although the controller 1230 is described above as being included in the driving module 1120, this is provided only as an example, and the controller 1230 may not be included in the driving module 1120. The controller 1230, comprising processing circuitry, and the driving module 1120 may be disposed in the same housing (e.g., the housing 1020 of FIG. 10).

Referring to FIG. 13A, the wireless power transmitter 1130 may include, for example, a TX IC 1131 and a transmitting coil 1132 (e.g., the transmitting coil 930). Referring to FIG. 13B, the wireless power receiver 1140 may include a receiving coil 1141 (e.g., the receiving coil 910), an RX IC 1142, and a converter 1143 (e.g., a DC-DC converter). The converter 1143 may be included in the RX IC 1142, depending on the implementation.

In an example embodiment, when the wearable device 1100 is powered on, the processor 1110 may initiate communication with the controller 1230. The communication between the processor 1110 and the controller 1230 may be, for example, but is not limited to, RS-232 communication. The controller 1230 may initiate communication with the TX IC 1131. The communication between the controller 1230 and the TX IC 1131 may be, for example, but is not limited to, an inter-integrated circuit (I2C) method. The controller 1230 may initialize (or enable) the TX IC 1131.

In an example embodiment, the battery 1210 may provide DC power to the motor 1220 (e.g., the motor 534 or the motor 534-1), the controller 1230, and the wireless power transmitter 1130. Although not shown in FIG. 12, the wearable device 1100 may include a power management integrated circuit (PMIC), which may convert power from the battery 1210 into power (or voltage) suitable for each of the motor 1220, the controller 1230, and the wireless power transmitter 1130 and supply the power thereto.

In an example embodiment, the TX IC 1131 may initiate wireless communication with the RX IC 1142. The wireless communication between the TX IC 1131 and the RX IC 1142 may correspond to a wireless communication method of the Qi standard, for example, but is not limited thereto. The TX IC 1131 and the RX IC 1142 may perform a handshake operation. For example, in accordance with the Qi standard, the TX IC 1131 and the RX IC 1142 may perform the handshake operation for wireless charging.

In an example embodiment, the TX IC 1131 may receive the DC power from the battery 1210 (or the PMIC).

In an example embodiment, the TX IC 1131 may convert the supplied DC power into alternating current (AC) power. The TX IC 1131 may transfer the AC power to the transmitting coil 1132. As the current flows in the transmitting coil 1132, an electromagnetic field may be generated in the transmitting coil 1132.

In an example embodiment, the receiving coil 1141 of FIG. 13B may generate AC power (or AC current) due to the electromagnetic field generated by the transmitting coil 1132.

In an example embodiment, the RX IC 1142 and the converter 1143 may convert the AC power to DC power suitable for the torque sensor module 1150 which comprises a torque sensor.

For example, the RX IC 1142 may receive the AC power from the receiving coil 1141 and rectify the AC power to the DC power. The converter 1143 may receive the DC power from the RX IC 1142, and may step down a voltage (e.g., 9V, 12V, or 15V) of the received DC power to a voltage (e.g., 5V) suitable for the torque sensor module 1150.

In an example embodiment, the converter 1143 may supply the converted DC power (e.g., the stepped-down DC power) to the torque sensor module 1150.

In an example embodiment, the torque sensor module 1150 may include, for example, a torque sensor 1151 (or a strain sensor), an amplifier 1152, and a controller 1153. The amplifier 1152 and the controller 1153 may receive the converted DC power from the converter 1143.

In an example embodiment, the torque sensor 1151 may include a strain gauge. The torque caused by at least one of the operation of the driving module 1120 or the movement of the user may generate strain on a rotation axis, and based on this strain, the torque sensor 1151 may output an electrical signal (e.g., a voltage signal or a current signal).

In an example embodiment, the amplifier 1152 may amplify the electrical signal output by the torque sensor 1151 and remove noise from the amplified electrical signal (hereinafter also referred to as an amplification electrical signal). The amplifier 1152 may output the denoised amplification electrical signal to the controller 1153.

In an example embodiment, the controller 1153 may include an analog-to-digital converter (ADC).

Depending on the implementation, the torque sensor module 1150 may correspond to an integral torque sensor in which the strain gauge, a micro-electromechanical system (MEMS) sensor, the amplifier 1152, and the controller 1153 are integrated.

In an example embodiment, the controller 1153 may convert an output signal (e.g., the denoised amplification electrical signal) of the amplifier 1152 into a digital signal, using the ADC. The digital signal may correspond to the torque data described above. The controller 1153 may transfer the torque data to the RX IC 1142. The communication between the controller 1153 and the RX IC 1142 may be, for example, but is not limited to, the I2C method.

In an example embodiment, the RX IC 1142 may transmit the torque data to the wireless power transmitter 1130 via the receiving coil 1141. For example, the RX IC 1142 may modulate the torque data according to a modulation scheme and transmit the modulated torque data to the wireless power transmitter 1130 via the receiving coil 1141. The modulation scheme may include, for example, but is not limited to, a frequency shift keying (FSK) modulation scheme, a Manchester coding modulation scheme, a phase shift keying (PSK) modulation scheme, a pulse width modulation scheme, a differential bi-phase modulation scheme, or the like.

In an example embodiment, the TX IC 1131 of the wireless power transmitter 1130 may receive the torque data from the wireless power receiver 1140 via the transmitting coil 1132. For example, the TX IC 1131 may receive the modulated torque data from the wireless power receiver 1140 via the transmitting coil 1132 and demodulate the modulated torque data. The TX IC 1131 may transfer the torque data to the controller 1230.

Referring back to FIG. 12, the angle sensor 1240 may generate joint angle data by measuring a joint angle (e.g., a hip joint angle) of the user. The angle sensor 1240 may transfer the joint angle data to the controller 1230. The description of the angle sensor 1240 may apply to the first angle sensor 524 and the second angle sensor 524-1.

The controller 1230 may transfer the joint angle data and the torque data to the processor 1110. Depending on embodiments, the controller 1230 may combine the joint angle data and the torque data to generate combined data and transfer the combined data to the processor 1110. However, embodiments are not limited thereto, and the controller 1230 may transfer the joint angle data and the torque data separately to the processor 1110.

In an example embodiment, the processor 1110 may determine power (or a force) generated by the user at different joint angles of the user based on the joint angle data and the torque data. For example, the processor 1110 may extract, from the torque data, a value of a torque generated by a movement of the user. In this example, the processor 1110 may extract the value of the torque generated by the movement of the user from the torque data by subtracting a value of a torque generated by the driving module 1120 from the torque data. The torque generated by the driving module 1120 may be proportional to a current supplied to the motor 1220 in the driving module 1120. The value of the torque generated by the driving module 1120 may be calculated based on a value of the current supplied to the motor 1220 in the driving module 1120. The processor 1110 may acquire, using the joint angle data, angular velocity data of a joint of the user. The processor 1110 may multiply, according to the following equation, “power=torque×angular velocity,” the extracted value and the angular velocity data to determine the power generated by the user at various joint angles of the user. Accordingly, a power meter capable of measuring the power may be implemented according to an example embodiment. The processor 1110 may transfer information about the determined power (e.g., the power generated by the user at various joint angles) to the electronic device 210 via a communication module (e.g., the communication module 516, comprising communication circuitry). The processor 1110 may thus determine how much power the user has used at which joint angle when the user moves (or exercises).

In an example embodiment, the electronic device 210 may receive the information about the determined power from the wearable device 1100. The electronic device 210 may display the information about the determined power on the display module 740 of the electronic device 210. For example, the display module 740 may provide a visual representation of how much power the user has generated for a movement at different joint angles. The user may thus easily identify how much power the user has used for any joint angle.

In an example embodiment, the electronic device 210 may provide the user with a guide for movement of the user based on the information about the determined power. For example, the electronic device 210 may determine, from the information about the determined power, that a certain level of power has not been generated at a first joint angle of the user, which is supposed to be generated for the first joint angle. In this case, the electronic device 210 may guide the user to exert a greater amount of power at the first joint angle.

In an example embodiment, the processor 1110 may provide an additional torque to the user according to an environment (e.g., uphill, etc.) around the user. For example, when the user is walking uphill or walking up the stairs, the value of the torque data acquired by the torque sensor module 1150 may differ by a certain level from the value of the torque generated by the driving module 1120. That is, when the user is walking uphill or walking up the stairs, the user may move with insufficient power, which may interfere with the operation of the driving module 1120. As a result, the value of the torque data acquired by the torque sensor module 1150 may differ by more than the certain level from the value of the torque generated by the driving module 1120. In this case, the processor 1110 may determine to provide an additional torque (or additional external force) to the user. The user may thus receive a greater external force from the wearable device 1100.

In an example embodiment, an output link (e.g., the output link 830 of FIG. 8) may be rotated by the driving module 1120. The wireless power receiver 1140 and the torque sensor module 1150 of FIG. 11A may be disposed on the output link. Depending on embodiments, the torque sensor module 1150 and the output link may be integral.

In an example embodiment, in the output link, a wear detection sensor (not shown) configured to detect whether the wearable device is worn on the user may be disposed. The converter 1143 may supply the converted DC power to the wear detection sensor. The wear detection sensor may transfer a wear detection result acquired by the detection to the RX IC 1142. The RX IC 1142 may transmit the wear detection result to the wireless power transmitter 1130 via the receiving coil 1141. TX IC 1131 may receive the wear detection result from the wireless power receiver 1140 and transfer the wear detection result to the processor 1110 via the controller 1230. Based on the wear detection result, the processor 1110 may determine whether the user is wearing the wearable device 1100.

The embodiments described with reference to FIGS. 1 through 10 may apply to the embodiments described with reference to FIGS. 11A through 13B.

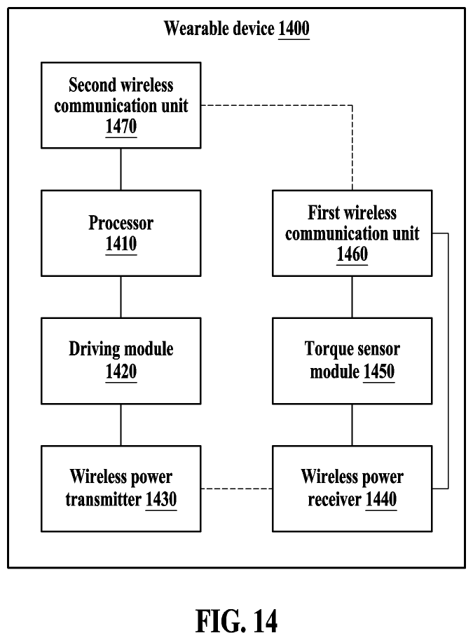

FIGS. 14 through 16B are block diagrams illustrating other example configurations of a wearable device according to an embodiment.

Referring to FIG. 14, a wearable device 1400 (e.g., the wearable device 100) may include a processor 1410 (e.g., the processor 512), a driving module 1420 (e.g., the driving module 810), a wireless power transmitter 1430 (e.g., the wireless power transmitter 1130), a wireless power receiver 1440 (e.g., the wireless power receiver 1140), a torque sensor module 1450 (e.g., the torque sensor module 820 and the torque sensor module 1150), a first wireless communication unit 1460, and a second wireless communication unit 1470. The first wireless communication unit 1460 and/or the second wireless communication unit 1470 may be included in the communication module 516.

The preceding description of the processor 1110, the driving module 1120, the wireless power transmitter 1130, the wireless power receiver 1140, and the torque sensor module 1150 may apply, respectively, to the processor 1410, the driving module 1420, the wireless power transmitter 1430, the wireless power receiver 1440, and the torque sensor module 1450 of FIG. 14.

In an example embodiment, the driving module 1420 may generate power (or torque) to be applied to a user.

In an example embodiment, the torque sensor module 1450 may generate torque data by measuring a torque caused by at least one of an operation of the driving module 1420 or a movement of the user.

In an example embodiment, the wireless power transmitter 1430 may communicate with the driving module 1420 and/or the processor 1410.

In an example embodiment, the wireless power transmitter 1430 may perform wireless power transmission. The wireless power transmitter 1430 may transmit wireless power to the wireless power receiver 1440.

In an example embodiment, the wireless power receiver 1440 may receive the wireless power from the wireless power transmitter. The wireless power receiver 1440 may convert the received wireless power and supply the converted wireless power to the torque sensor module 1450.

In an example embodiment, the first wireless communication unit 1460 may form a wireless communication link with the second wireless communication unit 1470. The first wireless communication unit 1460 and the second wireless communication unit 1470 may each include, for example, but is not limited to, a Bluetooth module, a Bluetooth low energy (BLE) module, or a near field communication (NFC) module.

In an example embodiment, the first wireless communication unit 1460 may include a small battery embedded therein, and may receive power from the small battery to operate. Depending on the implementation, the first wireless communication unit 1460 may not include the small battery. The wireless power receiver 1440 may convert the received wireless power into wireless power suitable for the first wireless communication unit 1460 and supply the converted wireless power to the first wireless communication unit 1460.

In an example embodiment, the first wireless communication unit 1460 may receive the torque data from the torque sensor module 1450. The first wireless communication unit 1460 may transmit the torque data to the second wireless communication unit 1470. The processor 1410 may receive the torque data from the second wireless communication unit 1470. The processor 1410 may receive the torque data from the torque sensor module 1450 through wireless communication. The processor 1410 may generate a control signal for controlling the driving module 1420 based on the torque data and movement information (e.g., joint angle values) of the user. The processor 1410 may control the driving module 1420 based on the generated control signal.

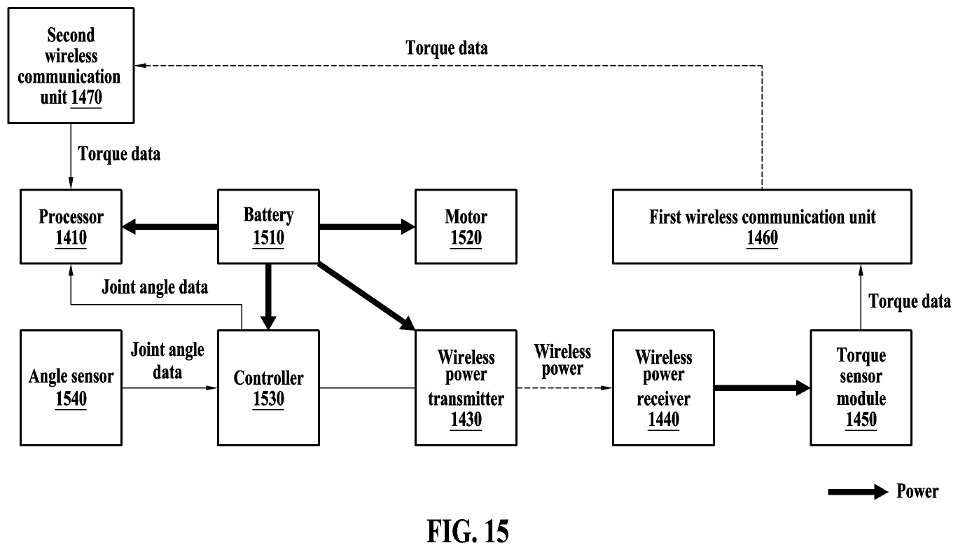

In an example embodiment, referring to FIG. 15, the wearable device 1400 may include a battery 1510 (e.g., the battery 1210), and the driving module 1420 may include, for example, a motor 1520, a controller 1530 (e.g., the controller 1230 of FIG. 12), and an angle sensor 1540 (e.g., the angle sensor 1240 of FIG. 12). Although the controller 1530 is described above as being included in the driving module 1420, this is provided only as an example, and the controller 1530 may not be included in the driving module 1420. The controller 1530 and the driving module 1420 may be disposed in the same housing (e.g., the housing 1020 of FIG. 10).

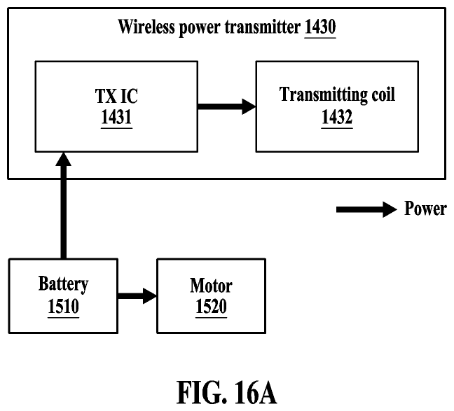

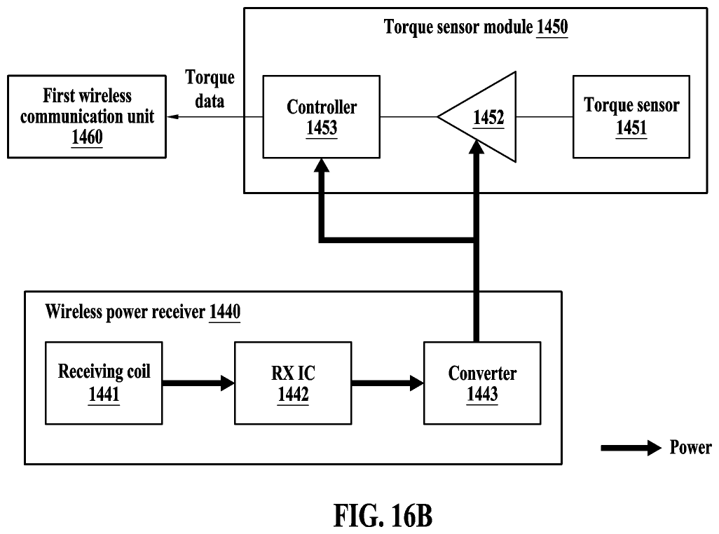

Referring to FIG. 16A, the wireless power transmitter 1430 may include, for example, a TX IC 1431 (e.g., the TX IC 1131 of FIG. 12A) and a transmitting coil 1432 (e.g., the transmitting coil 1132 of FIG. 12A). Referring to FIG. 16B, the wireless power receiver 1440 may include a receiving coil 1441 (e.g., the receiving coil 1141 of FIG. 12B), an RX IC 1442 (e.g., the RX IC 1142 of FIG. 12B), and a converter 1443 (e.g., the converter 1143 of FIG. 12B). Depending on the implementation, the converter 1443 may be included in the RX IC 1442.

In an example embodiment, the battery 1510 may supply DC power to the motor 1520, the controller 1530, and the wireless power transmitter 1430. Although not shown in FIG. 15, the wearable device 1400 may include a PMIC, which may convert power from the battery 1510 into power (or voltage) suitable for each of the motor 1520, the controller 1530, and the wireless power transmitter 1430.

In an example embodiment, the TX IC 1431 may receive the DC power from the battery 1510 (or the PMIC).

In an example embodiment, the TX IC 1431 may convert the supplied DC power into AC power. The TX IC 1431 may transfer the AC power to the transmitting coil 1432. As the current flows in the transmitting coil 1432, an electromagnetic field may be generated in the transmitting coil 1432.

In an example embodiment, the receiving coil 1441 of FIG. 16B may have AC power (or AC current) generated by the electromagnetic field generated by the transmitting coil 1432. The RX IC 1442 may receive the AC power from the receiving coil 1441 and rectify the AC power to DC power.

In an example embodiment, the converter 1443 may receive the DC power from the RX IC 1442 and step down a voltage of the received DC power to a voltage (e.g., 5V) suitable for the torque sensor module 1450. The converter 1443 may supply the converted DC power (e.g., the stepped-down DC power) to the torque sensor module 1450.

In an example embodiment, the torque sensor module 1450 may include, for example, a torque sensor 1451 (e.g., the torque sensor 1151), an amplifier 1452 (e.g., the amplifier 1152), and a controller 1453 (e.g., the controller 1153). The amplifier 1452 and the controller 1453 may receive the converted DC power from the converter 1443.

The torque sensor module 1450 may generate the torque data by detecting strain generated on a rotation axis. The torque data may include a measured value of the torque caused by at least one of the movement of the user or the operation of the driving module 1420. The preceding description of the torque sensor module 1150 may apply to the torque sensor module 1450.

In an example embodiment, the first wireless communication unit 1460 may receive the torque data from the torque sensor module 1450 and transmit the torque data to the second wireless communication unit 1470. The processor 1410 may receive the torque data from the second wireless communication unit 1470.

Referring back to FIG. 15, the angle sensor 1540 may generate joint angle data by measuring a joint angle (e.g., a hip joint angle) of the user. The angle sensor 1540 may transfer the joint angle data to the controller 1530. The controller 1530 may transfer the joint angle data to the processor 1410.

In an example embodiment, the processor 1410 may determine power generated by the user at different joint angles of the user based on the joint angle data and the torque data. The processor 1410 may transfer information about the determined power (e.g., the power generated by the user at the various joint angles) to the electronic device 210 via the second wireless communication unit 1470.

In an example embodiment, the electronic device 210 may receive the information about the determined power from the wearable device 1400. The electronic device 210 may display the information about the determined power on a display. The user may thus easily determine how much power the user has used for any joint angle.

In an example embodiment, the electronic device 210 may provide the user with a guide for movement of the user based on the information about the determined power. For example, the electronic device 210 may determine, from the information about the determined power, that a certain level of power has not been generated at a first joint angle of the user, which is supposed to be generated for the first joint angle. In this case, the electronic device 210 may guide the user to use a greater amount of power at the first joint angle.

In an example embodiment, the wireless power receiver 1440, the torque sensor module 1450, and the first wireless communication unit 1460 may be disposed on an output link (e.g., the output link 830 of FIG. 8). Depending on embodiments, the torque sensor module 1450 and the output link may be integral.

In an example embodiment, in the output link, a wear detection sensor (not shown) configured to detect whether the wearable device is worn on the user may be disposed. The converter 1443 may convert a voltage of the DC power into a voltage suitable for the wear detection sensor and supply the converted DC power to the wear detection sensor. The wear detection sensor may transfer a wear detection result acquired by the detection to the first wireless communication unit 1460. The first wireless communication unit 1460 may transmit the wear detection result to the second wireless communication unit 1470. The processor 1410 may receive the wear detection result from the second wireless communication unit 1470. Based on the wear detection result, the processor 1410 may determine whether the user is wearing the wearable device 1400.

The embodiments described with reference to FIGS. 1 through 13B may apply to the embodiments described with reference to FIGS. 14 through 16B.

The embodiments described with reference to FIGS. 1 through 16B may be applied to robots (e.g., manipulators, etc.) that may operate without being worn on a user.

According to an example embodiment, a wearable device (100; 1100; 1400) configured to be worn on a body of a user may include: a driving module (810; 1120; 1420) configured to generate an external force to be applied to the user; a torque sensor module (820; 1150; 1450) configured to generate torque data by measuring a torque caused by at least one of an operation of the driving module or a movement of the user; a wireless power transmitter (1130; 1430) configured to perform wireless power transmission; a wireless power receiver (1140; 1440) configured to receive wireless power transmitted by the wireless power transmitter, convert the received wireless power, supply the converted wireless power to the torque sensor module, and receive the torque data from the torque sensor module and transmit the received torque data to the wireless power transmitter; and a processor (512; 1110; 1410) configured to control the driving module such that the driving module generates the external force, receive the torque data from the wireless power transmitter via the driving module, and evaluate the movement using the torque data.

The wearable device may further include an output link connected, directly or indirectly, to the driving module.

The torque sensor module and the wireless power receiver may be disposed on the output link.

A transmitting coil of the wireless power transmitter may be disposed in a housing of the driving module, and a receiving coil of the wireless power receiver may be disposed on a first surface of the output link to face the transmitting coil.

The driving module may include: an angle sensor (1240; 1540) configured to acquire joint angle data by measuring a joint angle of the user; and a controller (1230; 1530) configured to receive the acquired joint angle data from the angle sensor and transfer the received joint angle data to the processor.

The processor may be configured to determine, based on the received joint angle data and the torque data, power generated by the user at various joint angles of the user.

The wearable device may further include a communication module (516) configured to form a wireless communication link with an electronic device of the user.

The processor may be configured to transmit, via the communication module, the determined power to the electronic device.

The processor may be configured to determine, based on the received joint angle data and the torque data, a joint angle for which an additional external force is required by the user.

In response to receiving the torque data from the wireless power receiver, the wireless power transmitter may be configured to transfer the torque data to the controller, and the controller may be configured to transfer the torque data to the processor.

The driving module may include a motor.

The processor may be configured to acquire, using the torque sensor module, a measured value of a torque generated by a movement of the user wearing the wearable device in a first state where power is not supplied to the motor; determine, using the acquired measured value, reference information on which a torque output of the driving module is based; determine a torque value of a torque to be generated by the driving module based on the determined reference information in a second state where power is supplied to the motor; and control the driving module such that the driving module outputs the torque corresponding to the determined torque value.

The wearable device may further include a wear detection sensor configured to detect whether the user is wearing the wearable device and transfer a detection result acquired by the detecting to the wireless power receiver.

The wireless power transmitter may be configured to receive the detection result from the wireless power receiver and transfer the detection result to the processor via the driving module.

According to an example embodiment, a wearable device (100; 1100; 1400) worn on a body of a user may include: a driving module (810; 1120; 1420) configured to generate an external force to be applied to the user; a torque sensor module (820; 1150; 1450) configured to generate torque data by measuring a torque caused by at least one of an operation of the driving module or a movement of the user; a wireless power transmitter (1130; 1430) configured to perform wireless power transmission; a wireless power receiver (1140; 1440) configured to receive wireless power transmitted by the wireless power transmitter, convert the received wireless power, and supply the converted wireless power to the torque sensor module; a first wireless communication unit (1460), comprising communication circuitry, configured to receive the torque data from the torque sensor module; a second wireless communication unit (1470), comprising communication circuitry, configured to receive the torque data from the first wireless communication unit; and a processor (512; 1110; 1410) configured to control the driving module to generate the external force, receive the torque data from the second wireless communication unit, and evaluate the movement using the torque data.

The wearable device may further include an output link connected to the driving module.

The torque sensor module, the wireless power receiver, and the wireless communication unit may be disposed on the output link.

A transmitting coil of the wireless power transmitter may be disposed in a housing of the driving module, and a receiving coil of the wireless power receiver may be disposed on a first surface of the output link to face the transmitting coil.

The driving module may include: an angle sensor configured to acquire joint angle data by measuring a joint angle of the user; and a controller, comprising processing circuitry, configured to receive the acquired joint angle data from the angle sensor and transfer the received joint angle data to the processor.

The processor may be configured to: determine, based on the received joint angle data and the torque data, power generated by the user at various joint angles of the user.

The second wireless communication unit, comprising communication circuitry, may form a wireless communication link with an electronic device of the user.

The processor may be configured to transmit the determined power to the electronic device of the user via the second wireless communication unit.

The processor may be configured to determine, based on the received joint angle data and the torque data, a joint angle for which an additional external force is required by the user.

In response to receiving the torque data from the wireless power receiver, the wireless power transmitter may be configured to transfer the torque data to the controller, and the controller may be configured to transfer the torque data to the processor.

The driving module may include a motor.

The processor may be configured to acquire, using the torque sensor module, a measured value of a torque generated by a movement of the user wearing the wearable device in a first state where power is not supplied to the motor; determine, based on the acquired measured value, reference information on which a torque output of the driving module is based; determine, based on the determined reference information, a torque value of a torque to be generated by the driving module in a second state where power is supplied to the motor; and control the driving module such that the driving module outputs the torque corresponding to the determined torque value. “Based on” as used herein covers based at least on.

The wearable device may further include a wear detection sensor configured to detect whether the user is wearing the wearable device and transmit a detection result acquired by the detecting to the processor via the wireless communication unit.

According to an example embodiment, an operating method of a wearable device (100; 1100; 1400) may include: providing, by a driving module (810; 1120; 1420) in the wearable device, an external force to a user; transmitting, by a wireless power transmitter (1130; 1430) in the wearable device, wireless power to a wireless power receiver (1140; 1440) in the wearable device; converting, by the wireless power receiver, the wireless power; supplying, by the wireless power receiver, the converted wireless power to a torque sensor module (820; 1150; 1450) in the wearable device; generating, by the torque sensor module in the wearable device, torque data by measuring a torque caused by at least one of an operation of the driving module of the wearable device and a movement of the user; transmitting, by the wireless power receiver, the torque data to the wireless power transmitter; transferring, by the wireless power transmitter, the torque data to a processor (512; 1110; 1410) in the wearable device; and evaluating, by the processor, the movement using the torque data.

The operating method may further include: acquiring joint angle data by measuring a joint angle of the user; and determining, based on the acquired joint angle data and the torque data, power generated by the user for the movement.

The example embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof to, independently or collectively, instruct or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

Therefore, in addition to the above disclosure, the scope of the disclosure may also be defined by the claims and their equivalents, and all variations within the scope of the claims and their equivalents are to be construed as being included in the disclosure.

1. A wearable device configured to be worn on a body of a user, comprising:
a driving module, comprising a motor and/or circuitry, configured to generate an external force to be applied to the user;
a torque sensor module, comprising a sensor, configured to generate torque data at least by measuring a torque caused by at least one of an operation of the driving module or a movement of the user;
a wireless power transmitter configured to perform wireless power transmission;
a wireless power receiver configured to receive wireless power transmitted by the wireless power transmitter, convert the received wireless power, supply the converted wireless power to the torque sensor module, and receive the torque data from the torque sensor module and transmit the received torque data to the wireless power transmitter; and
a processor, comprising processing circuitry, configured to control the driving module such that the driving module generates the external force, receive the torque data from the wireless power transmitter via the driving module, and evaluate the movement using the torque data.

2. The wearable device of claim 1, further comprising:
a rotatable output link connected to the driving module,
wherein the torque sensor module and the wireless power receiver are disposed on the output link.

3. The wearable device of claim 2, wherein a transmitting coil of the wireless power transmitter is at least partially disposed in a housing of the driving module, and a receiving coil of the wireless power receiver is at least partially disposed on a first surface of the output link to face the transmitting coil.

4. The wearable device of claim 1, wherein the driving module further comprises:
an angle sensor configured to acquire joint angle data by measuring a joint angle of the user; and
a controller, comprising processing circuitry, configured to receive the acquired joint angle data from the angle sensor and transfer the received joint angle data to the processor,
wherein the processor is further configured to:
determine, based on the received joint angle data and the torque data, power generated by the user at various joint angles of the user.

5. The wearable device of claim 4, wherein the processor is configured to: transmit, via a communication module comprising communication circuitry that forms at least part of a wireless communication link with an electronic device of the user, the determined power to the electronic device; and/or determine, based on the received joint angle data and the torque data, a joint angle for which an additional external force is required by the user.

6. The wearable device of claim 4, wherein, in response to receiving the torque data from the wireless power receiver, the wireless power transmitter is configured to transfer the torque data to the controller, and the controller is configured to transfer the torque data to the processor.

7. The wearable device of claim 1, wherein the driving module comprises a motor,
wherein the processor is configured to acquire, using the torque sensor module, a measured value of a torque generated by a movement of the user wearing the wearable device in a first state where power is not supplied to the motor; determine, using the acquired measured value, reference information on which a torque output of the driving module is based; determine a torque value of a torque to be generated by the driving module based on the determined reference information in a second state where power is supplied to the motor; and control the driving module such that the driving module outputs the torque corresponding to the determined torque value.

8. The wearable device of claim 1, further comprising:
a wear detection sensor configured to detect whether the user is wearing the wearable device and transfer a detection result acquired by the detecting to the wireless power receiver,
wherein the wireless power transmitter is configured to receive the detection result from the wireless power receiver and transfer the detection result to the processor via the driving module.

9. A wearable device configured to be worn on a body of a user, comprising:
a driving module, comprising a motor and/or circuitry, configured to generate an external force to be applied to the user;
a torque sensor module, comprising a sensor, configured to generate torque data at least by measuring a torque caused by at least one of an operation of the driving module or a movement of the user;
a wireless power transmitter configured to perform wireless power transmission;
a wireless power receiver configured to receive wireless power transmitted by the wireless power transmitter, convert the received wireless power, and supply the converted wireless power to the torque sensor module;
a first wireless communication unit, comprising circuitry, configured to receive the torque data from the torque sensor module;
a second wireless communication unit, comprising circuitry, configured to receive the torque data from the first wireless communication unit; and
a processor, comprising processing circuitry, configured to control the driving module such that the driving module generates the external force, receive the torque data from the second wireless communication unit, and evaluate the movement using the torque data.

10. The wearable device of claim 9, further comprising:
an output link connected to a wear detection sensor configured to detect whether the user is wearing the wearable device and transmit a detection result acquired by the detecting to the processor via the wireless communication unit or connected to the driving module,
wherein the torque sensor module, the wireless power receiver, and the wireless communication unit are disposed on the output link.

11. The wearable device of claim 10, wherein a transmitting coil of the wireless power transmitter is disposed in a housing of the driving module, and a receiving coil of the wireless power receiver is disposed on a first surface of the output link to face the transmitting coil.

12. The wearable device of claim 9, wherein the driving module further comprises:
an angle sensor configured to acquire joint angle data at least by measuring a joint angle of the user; and
a controller, comprising processing circuitry, configured to receive the acquired joint angle data from the angle sensor and transfer the received joint angle data to the processor,
wherein the processor is configured to:
determine, based on the received joint angle data and the torque data, power generated by the user at various joint angles of the user.

13. The wearable device of claim 12, wherein the processor is configured to:
transmit the determined power to an electronic device of the user via the second wireless communication unit; and/or
determine, based on the received joint angle data and the torque data, a joint angle for which an additional external force is required by the user.

14. The wearable device of claim 12, wherein, in response to receiving the torque data from the wireless power receiver, the wireless power transmitter is configured to transfer the torque data to the controller, and the controller is configured to transfer the torque data to the processor.

15. The wearable device of claim 9, wherein the driving module comprises a motor,
wherein the processor is configured to acquire, using the torque sensor module, a measured value of a torque generated by a movement of the user wearing the wearable device in a first state where power is not supplied to the motor; determine, based on the acquired measured value, reference information on which a torque output of the driving module is based; determine, based on the determined reference information, a torque value of a torque to be generated by the driving module in a second state where power is supplied to the motor; and control the driving module such that the driving module outputs the torque corresponding to the determined torque value.
